(19) United States
(12) Patent Application Publication
(10) Pub. No.: US 2010/0315541 A1
(43) Pub. Date: Dec. 16, 2010

(54) SOLID-STATE IMAGING DEVICE INCLUDING IMAGE SENSOR

(76) Inventor: Yoshitaka EGAWA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/813,129

(22) Filed: Jun. 10, 2010

(30) Foreign Application Priority Data
Jun. 12, 2009 (JP) 2009-141429

(51) Int. Cl. H04N 5/335

(52) U.S. Cl. 348/294; 348/E05.091

(57) ABSTRACT

According to one embodiment, a solid-state imaging device includes a sensor unit, a resolution extraction circuit and a generation circuit. The sensor unit has a transparent (W) filter and color filters of at least two colors which separate wavelengths of light components that have passed through an optical lens having at least one of spherical aberration and chromatic aberration. The sensor unit converts light that has passed through the transparent filter into a signal W and converts light components that have passed through the color filters into at least first and second color signals. The resolution extraction circuit extracts a resolution signal from signal W converted by the sensor unit. The generation circuit generates red (R), green (G) and blue (B) signals from signal W and the first and second color signals converted by the sensor unit.

### CROSS-REFERENCE TO RELATED APPLICATIONS

This application is based upon and claims the benefit of priority from Japanese Patent Application No. 2009-141429, filed Jun. 12, 2009; the entire contents of which are incorporated herein by reference.

### FIELD

Embodiments described herein relate generally to a solid-state imaging device including an image sensor such as a CMOS image sensor or a charge-coupled device (CCD) image sensor, and such a device is used in, e.g., a mobile phone, a digital camera or a video camera having an image sensor.

### BACKGROUND

In a camera module mounted in a mobile phone, a reduction in size of the camera module involved in a decrease in thickness of a mobile phone or realization of a camera module which is hardly damaged even if a mobile phone is dropped has been demanded. Further, in recent years, with a demand for high image quality, an increase in number of pixels, e.g., five megapixels, eight megapixels or more has been advanced.

In a sensor having many pixels, the depth of field becomes shallow with a reduction in pixel size. When the depth of field becomes shallow, an autofocus (AF) mechanism is required. However, reducing a size of a camera module having the AF mechanism is difficult, and there occurs a problem that the camera module is apt to be damaged when dropped.

Thus, a method of increasing the depth of field without using the AF mechanism, i.e., a method of increasing the depth of filed has been demanded. For this method of increasing the depth of field, studies and developments using an optical mask have been conventionally conducted. As the method of increasing the depth of field, a method of causing defocusing by using an optical lens itself and correcting it by signal processing has been suggested besides narrowing an aperture of the lens.

A solid-state imaging element that is currently generally utilized in a mobile phone or a digital camera adopts a Bayer arrangement which is a single-plate 2×2 arrangement basically including two green (G) pixels, one red (R) pixel and one blue (B) pixel in a color filter. Additionally, a resolution signal is extracted from signal G.

According to defocusing method that increases depth of field, a resolution signal level obtained from signal G decreases as the depth of focus increases. Thus, the resolution signal level must be greatly amplified, but there is a problem that noise increases at the same time.

Further, a method of refining a resolution by a deconvolution conversion filter (DCF) that performs deconvolution with respect to a point spread function (PSF) of a lens has been suggested. Making uniform the PSF within a plane of the lens is difficult. Therefore, a large quantity of DCF conversion parameters are required, and circuit scale increases, which results in an expensive camera module. In particular, an inexpensive camera module for a mobile phone has a problem that characteristics are not matched with a price.

### BRIEF DESCRIPTION OF THE DRAWINGS

FIG. 1 is a view showing an outline configuration of a solid-state imaging device using a CMOS image sensor according to a first embodiment;

FIGS. 2A, 2B, 2C and 2D are views each showing how interpolation processing for each signal W, G, R or B is performed in a pixel interpolation circuit depicted in FIG. 1;

FIGS. 3A, 3B and 3C are views each showing how a contour signal is generated in a contour extraction circuit depicted in FIG. 1;

FIG. 4 is a characteristic view showing spectral sensitivity characteristics in the solid-state imaging device according to the first embodiment;

FIG. 5A is a view showing focal properties when a lens having spherical aberration is used as an optical lens depicted in FIG. 1;

FIG. 5B is a view showing focal properties in a regular lens;

FIG. 5C is a view showing another example of area division of the spherically aberrant lens in the first embodiment;

FIG. 6 is a view showing a specific design example of the spherically aberrant lens depicted in FIG. 5A;

FIG. 7 is a view showing resolution characteristics of the spherically aberrant lens depicted in FIG. 6;

FIG. 8A is a view showing depth of field when a lens having chromatic aberration is used as the optical lens depicted in FIG. 1;

FIG. 8B is a characteristic view showing a relationship between a distance to an object and a maximum value of a PSF in the optical lens depicted in FIG. 1;

FIG. 9A is a view showing depth of field when a phase-shift plate is arranged between the optical lens and a sensor chip depicted in FIG. 1;

FIG. 9B is a view showing depth of field when the phase-shift plate is arranged between the optical lens and the sensor chip depicted in FIG. 1;

FIG. 10 is a view showing an outline configuration of a solid-state imaging device using a CMOS image sensor according to a second embodiment;

FIGS. 11A, 11B and 11C are views each showing how interpolation processing for each signal G, R or B is carried out in a pixel interpolation circuit depicted in FIG. 10;

FIG. 12 is a characteristic view showing spectral sensitivity characteristics in the solid-state imaging device according to the second embodiment;

FIG. 13 is a view showing an outline configuration of a solid-state imaging device using a CMOS image sensor according to a third embodiment;

FIGS. 14A, 14B and 14C are views each showing how interpolation processing for each signal W, G or R is performed in a pixel interpolation circuit depicted in FIG. 13;

FIG. 15 is a characteristic view showing spectral sensitivity characteristics in the solid-state imaging device according to the third embodiment;

FIG. 16 is a characteristic view showing a modification of spectral sensitivity characteristics in the third embodiment;

FIGS. 17A and 17B are views each showing a color arrangement of color filters in a sensor unit in a solid-state imaging device according to a fourth embodiment;

FIG. 18A is a characteristic view showing spectral sensitivity characteristics of a solid-state imaging device having the color filters depicted in FIG. 17A;

FIG. 18B is a characteristic view showing a modification of spectral sensitivity characteristics of the solid-state imaging device having the color filters depicted in FIG. 17A;

FIG. 18C is a characteristic view showing spectral sensitivity characteristics of the solid-state imaging device having the color filters depicted in FIG. 17B;

FIG. 18D is a characteristic view showing a modification of spectral sensitivity characteristics of the solid-state imaging device having the color filters depicted in FIG. 17B;

FIGS. 19A and 19B are enlarged views each showing a sensor unit in a solid-state imaging device according to a fifth embodiment;

FIG. 20 is a cross-sectional view of a portion associated with pixels WGWG in the sensor unit depicted in FIG. 19A;

FIG. 21 is a characteristic view showing spectral sensitivity characteristics in the solid-state imaging device according to the fifth embodiment;

FIG. 22 is a view showing a first modification of a solid-state imaging device according to a sixth embodiment;

FIG. 23 is a view showing a second modification of the solid-state imaging device according to the sixth embodiment;

FIG. 24 is a view showing a third modification of the solid-state imaging device according to the sixth embodiment;

FIG. 25 is a cross-sectional view of a camera module when an embodiment is applied to the camera module; and

FIG. 26 is a view showing the configuration of a signal processing circuit employed in the solid-state imaging device of the embodiments.

### DETAILED DESCRIPTION

Embodiments will now be described hereinafter with reference to the accompanying drawings. For explanation, like reference numerals denote like parts throughout the drawings.

In general, according to one embodiment, a solid-state imaging device includes a sensor unit, a resolution extraction circuit and a generation circuit. The sensor unit has a transparent (W) filter and color filters of at least two colors that separate wavelengths of light components that have passed through an optical lens having at least one of spherical aberration and chromatic aberration. The sensor unit converts light that has passed through the transparent filter into a signal W and converts light components that have passed through the color filters into first and second color signals, respectively. The resolution extraction circuit extracts a resolution signal from signal W converted by the sensor unit. The generation circuit generates signals red (R), green (G) and blue (B) from signal W and the first and second color signals converted by the sensor unit.

### First Embodiment

A solid-state imaging device according to a first embodiment will be first explained.

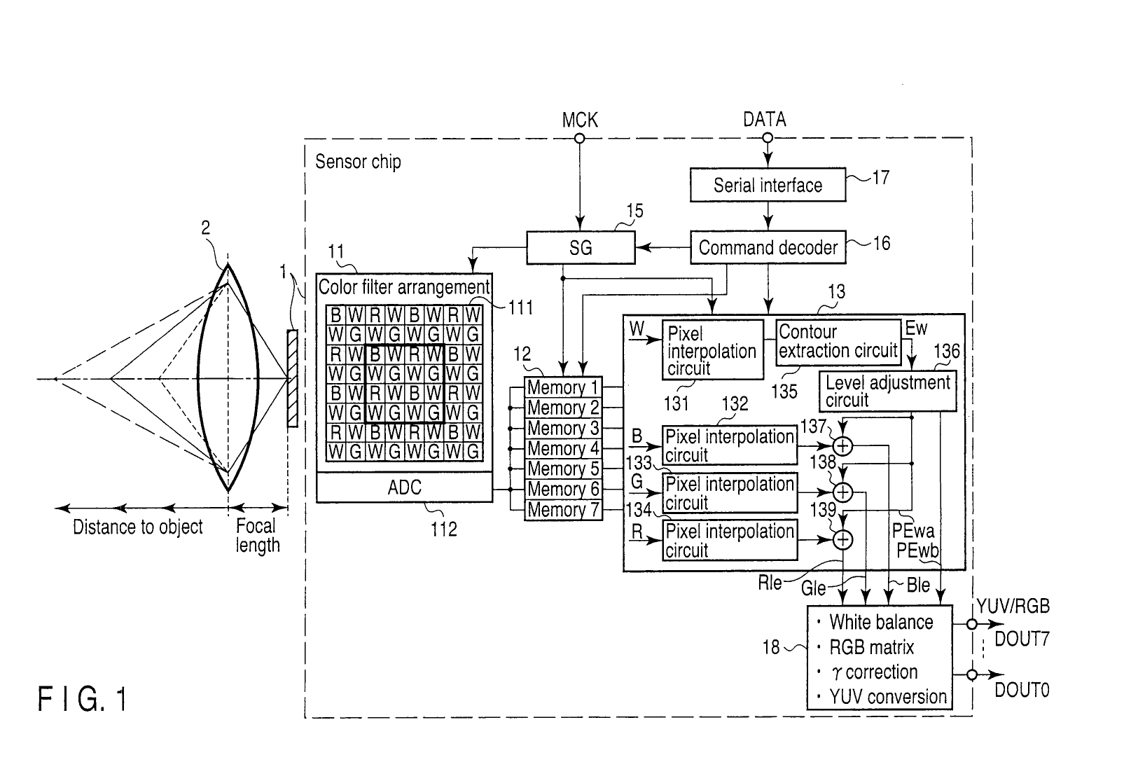

FIG. 1 is a view showing an outline configuration of a solid-state imaging device using a CMOS image sensor according to the first embodiment.

As shown in the drawing, an optical lens 2 is arranged above a sensor chip 1 including a CMOS image sensor. A space surrounded by a broken line in FIG. 1 represents a detailed configuration of the sensor chip 1. The optical lens 2 condenses optical information of a subject (an object). The sensor chip 1 has a built-in signal processing circuit and converts the light condensed by the optical lens 2 into an electrical signal to output a digital image signal. Although a detailed description will be given later, the optical lens 2 utilizes an aberration of the lens or an optical mask (e.g., a phase-shift plate) to increase depth of focus, i.e., increase depth of field.

The sensor chip 1 includes a sensor unit 11, a line memory 12, a resolution restoration circuit 13, a signal processing circuit 18, a system timing generation (SG) circuit 15, a command decoder 16 and a serial interface 17.

In the sensor unit 11, a pixel array 111 and a column-type analog-to-digital converter (ADC) 112 are arranged. Photodiodes (pixels) as photoelectric transducers means that transduce light components condensed by the optical lens 2 into electrical signals are two-dimensionally arranged on a silicon semiconductor substrate. Four types of color filters, transparent (W), blue (B), green (G) and red (R), are arranged on front surfaces of the photodiodes, respectively. As a color arrangement in the color filters, eight pixels W having a checkered pattern, four pixels G, two pixels R and two pixels B are arranged in a basic 4×4 pixel arrangement.

In the pixel array 111 in the sensor unit 11, a wavelength of light that enters the photodiodes (pixels) is divided into four by the color filters, and the divided light components are converted into signal charges by the two-dimensionally arranged photodiodes. Moreover, the signal charges are converted into a digital signal by the ADC 112 to be output. Additionally, in the respective pixels, microlenses are arranged on front surfaces of the color filters.

Signals output from the sensor unit 11 are supplied to the line memory 12 and, for example, signals corresponding to 7 vertical lines are stored in the line memory 12. The signals corresponding to the 7 lines are read out in parallel to be input to the resolution restoration circuit 13.

In the resolution restoration circuit 13, a plurality of pixel interpolation circuits 131 to 134 perform interpolation processing with respect to the respective signals W, B, G and R. Pixel signal W subjected to the interpolation processing is supplied to a contour (resolution) extraction circuit 135. The contour extraction circuit has a high-pass filter (HPF) circuit that extracts, e.g., a high-frequency signal, and extracts a contour (resolution) signal Ew by using the high-pass filter circuit. This contour signal Ew has its level properly adjusted by a level adjustment circuit 136, and the contour signals obtained by this adjustment are output as contour signals PEwa and PEwb. Contour signal PWwa is supplied to a plurality of addition circuits (resolution combination circuits) 137 to 139.

In the plurality of addition circuits 137 to 139, the respective signals B, G and R subjected to the interpolation processing by the pixel interpolation circuits 132 to 134 are added to level-adjusted contour signal PEwa. Signals Ble, Gle and Rle added by the addition circuits 137 to 139 and contour signal PEwb having the level adjusted by the level adjustment circuit 136 are supplied to the subsequent signal processing circuit 18.

The signal processing circuit 18 utilizes the received signals to carry out processing such as general white balance adjustment, color adjustment (RGB matrix), γ correction, YUV conversion and others, and outputs processing signals as digital signals DOUT0 to DOUT7 each having a YUV signal format or an RGB signal format. It is to be noted that the contour signal adjusted by the level adjustment circuit 136 can be added to a luminance signal (signal Y) in the subsequent signal processing circuit 18.

FIG. 26 shows a detailed configuration of the signal processing circuit 18. The signal processing circuit 18 comprises a white balance adjustment circuit 181, an RGB matrix circuit 182, a γ correction circuit 183, a YUV conversion circuit 184, an addition circuit 185, etc. The white balance adjustment circuit 181 receives signals Gle, Rle and Ble output from the resolution restoration circuit and makes white balance adjustment to them. The RGB matrix circuit 182 performs an operation expressed, for example, by formula (1) below with respect to output signals Gg, Rg and Bg of the white balance adjustment circuit 181.

$$[ \begin{matrix}Rm \\ Gm \\ Bm\end{matrix} ] = [ \begin{matrix}1.752 & - 0.822 & 0.072 \\ - 0.188 & 1.655 & - 0.467 \\ - 0.085 & - 0.723 & 1.808\end{matrix} ] \times [ \begin{matrix}Rg \\ Gg \\ Bg\end{matrix} ] \qquad ( 1 )$$

The coefficients in formula (1) can be varied in accordance with the spectral characteristics of a sensor, the color temperature and the color reproducibility desired.

The YUV conversion circuit 184 executes YUV conversion by performing an operation expressed, for example, by formula (2) below with respect to output signals R, G and B of the γ correction circuit 143.

$$[ \begin{matrix}Y \\ U \\ V\end{matrix} ] = [ \begin{matrix}0.299 & 0.588 & 0.113 \\ - 0.147 & - 0.289 & 0.436 \\ 0.345 & - 0.289 & - 0.56\end{matrix} ] \times [ \begin{matrix}Rin \\ Gin \\ Bin\end{matrix} ] + [ \begin{matrix}0 \\ 128 \\ 128\end{matrix} ] \qquad ( 2 )$$

Normally, the values in formula (2) are constants in order that the conversion of R, G and B signals and the conversion of YUV signals can be executed in common. A Y signal output from a YUV conversion circuit 184 is added to contour signal PEwb output from the resolution restoration circuit by the addition circuit 185, at a node connected to the output terminal of the YUV conversion circuit 184. The signal processing circuit 18 outputs digital signals DOUT0 to DOUT7 of the YUV or RGB signal format.

As can be seen from the above, the addition of a contour signal is performed (i) by the addition circuits 137 to 139 which add B, G and R signals and contour signal PEwa, (ii) by the signal processing circuit 18 which adds a Y signal subjected to YUV conversion processing and contour signal PWwb, or (iii) by a combination of i and ii.

After the level (signal amount) of contour signal PEwb is adjusted, the addition circuit 185 can add contour signal PEwb to a Y signal. The level of the contour signal PEwb can be adjusted by either the level adjustment circuit 136 or the addition circuit 185. The addition circuit 185 can add nothing to the Y signal by setting the level of the contour signal PEwb at “0”. In this case, the contour signal PEwb is not added to the Y signal, and the Y signal from the YUV conversion circuit 184 is output as it is. To the system timing generation (SG) circuit 15 is supplied a master clock signal MCK from the outside. The system timing generation circuit 15 outputs clock signals that control operations of the sensor unit 11, the line memory 12 and the resolution restoration circuit 13.

Further, operations of the line memory 12, the resolution restoration circuit 13 and the system timing generation circuit 15 are controlled by control signals output from the command decoder. For example, data DATA input from the outside is input to the command decoder 16 via the serial interface 17. Furthermore, the control signal decoded by the command decoder 16 is input to each circuit mentioned above, whereby processing parameters and others can be controlled based on the data DATA input from the outside.

It is to be noted that the subsequent signal processing circuit 18 can be divided for respective chips without being formed in the sensor chip 1. In this case, the respective signals B, G and R are thinned into a general Bayer arrangement (a basic configuration is a 2×2 arrangement having two pixels G, one pixel R and one pixel B).

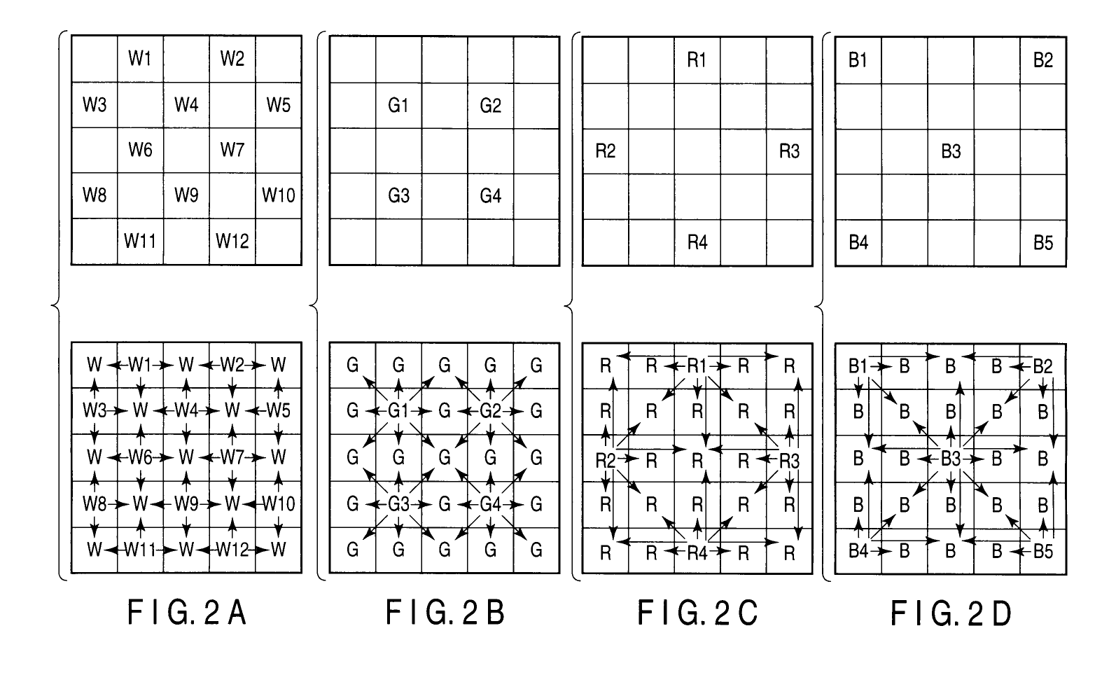

FIGS. 2A, 2B, 2C and 2D are views showing how the respective signals W, G, R and B are subjected to the interpolation processing in the pixel interpolation circuits 131 to 134 depicted in FIG. 1. It is to be noted that an upper side in each of FIGS. 2A, 2B, 2C and 2D shows a signal before the interpolation, and a lower side of the same shows a signal after the interpolation.

In FIGS. 2A, 2B, 2C and 2D, the interpolation is performed with an average value of signals of two pixels when the number of arrows is two, the interpolation is performed with an average value of signals of three pixels when the number of arrows is three, and the interpolation is performed with an average value of signals of four pixels when the number of arrows is four.

For example, paying attention to FIG. 2A, a signal W at a position surrounded by signals W1, W3, W4 and W6 provided at four positions is subjected to the interpolation with an average value of signals W1, W3, W4 and W6 at the four positions. Moreover, paying attention to FIG. 2B, a signal G placed between signals G1 and G2 provided at two positions is subjected to the interpolation with an average value of signals G1 and G2 provided at the two positions, and a signal G placed at the center of signals G1, G2, G3 and G4 provided at four positions is subjected to the interpolation with an average value of signals G1, G2, G3 and G4 provided at the four positions. The interpolation processing of signals R and signals B are as shown in FIGS. 2C and 2D.

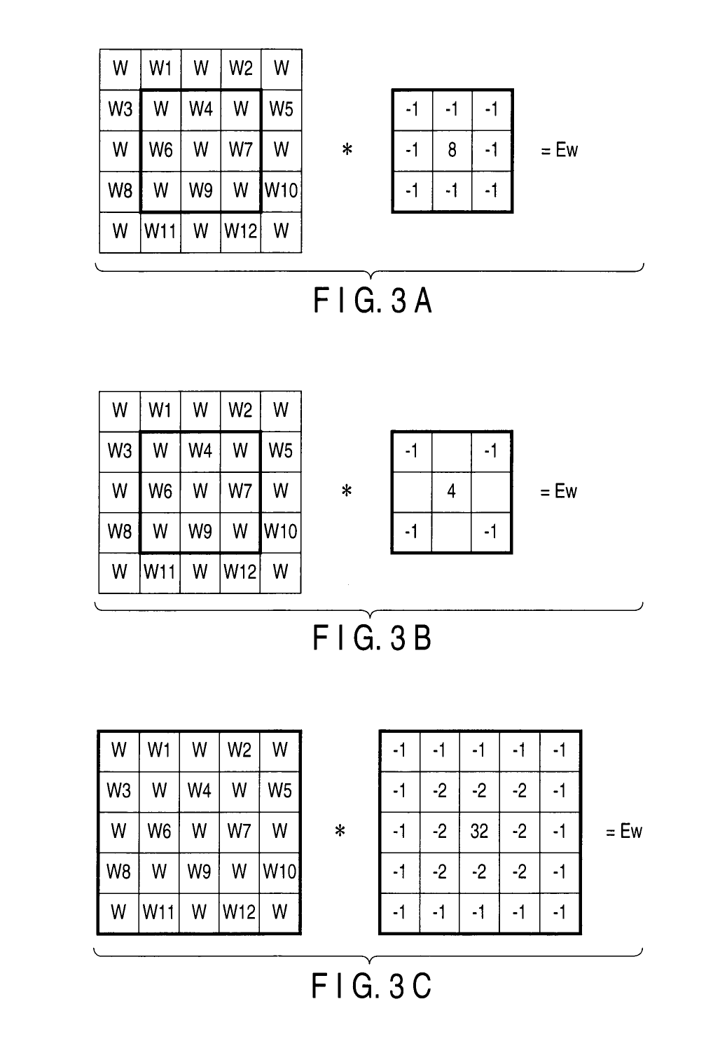

FIGS. 3A, 3B and 3C are views showing how a contour signal Ew is generated by the contour extraction circuit 135 for pixels W in FIG. 1.

According to a method depicted in FIG. 3A, a gain is octupled with respect to a central pixel in a 3×3 pixel area, a gain is multiplied by −1 with respect to each of surrounding eight pixels, and signals of these nine pixels are added to generate the contour signal Ew. In case of a uniform subject, the contour signal Ew becomes zero. On the other hand, when a vertical stripe or horizontal stripe pattern is generated, a control signal is produced.

According to a method depicted in FIG. 3B, a gain is quadrupled with respect to a central pixel in a 3×3 pixel area, a gain is multiplied by −1 for each of four pixels that are adjacent to the central pixel in oblique directions, and signals of these five pixels are added to generate the contour signal Ew.

According to a method depicted in FIG. 3C, a gain is multiplied by 32 with respect to a central pixel in a 5×5 pixel area, a gain is multiplied by −2 with respect to each of eight pixels surrounding the central pixel, a gain is multiplied by −1 with respect to each of 16 pixels surrounding the eight pixels, and signals of these 25 pixels are added to generate the contour signal Ew.

Besides the above-described methods, various methods can be used for generation of the contour signal. For example, besides the 3×3 pixel area and 5×5 pixel area, a 7×7 pixel area may be adopted, and weighting (gain) of each pixel may be changed. The generation of the contour signal for each pixel R, G or B excluding pixel W can be carried out by the same method as that depicted in each of FIGS. 3A, 3B and 3C. At this time, the contour signal may be generated by using a 7×7 pixel area.

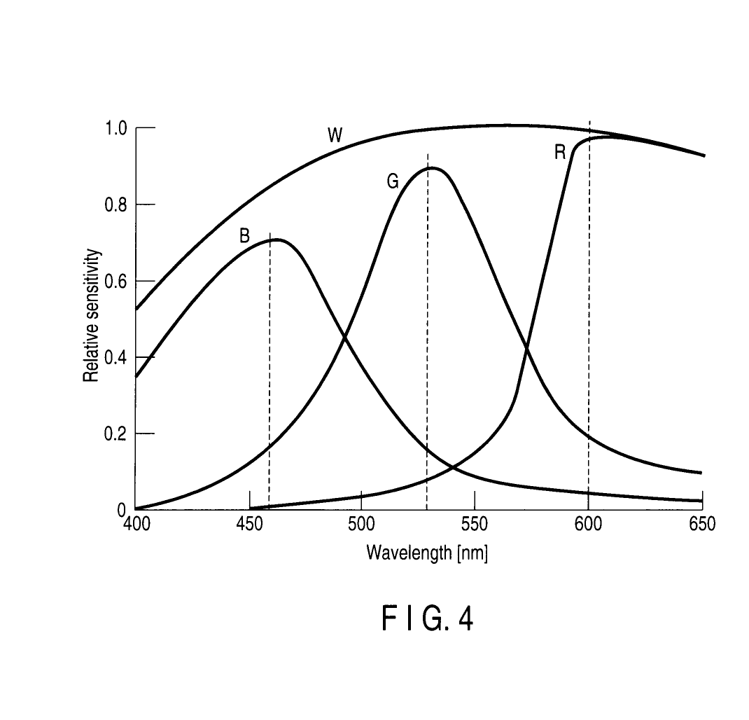

FIG. 4 is a characteristic view showing spectral sensitivity characteristics in the solid-state imaging device according to the first embodiment. As shown in the drawing, a peak of spectral characteristics of signal B is 460 nm, a peak of spectral characteristics of signal G is 530 nm, and a peak of spectral characteristics of signal R is 600 nm. Since a transparent layer is used for the color filter, signal W has high sensitivity and characteristics that are gentle from 400 to 650 nm. Therefore, a level of signal W obtained from pixel W can be approximately twofold or more of a level of signal G.

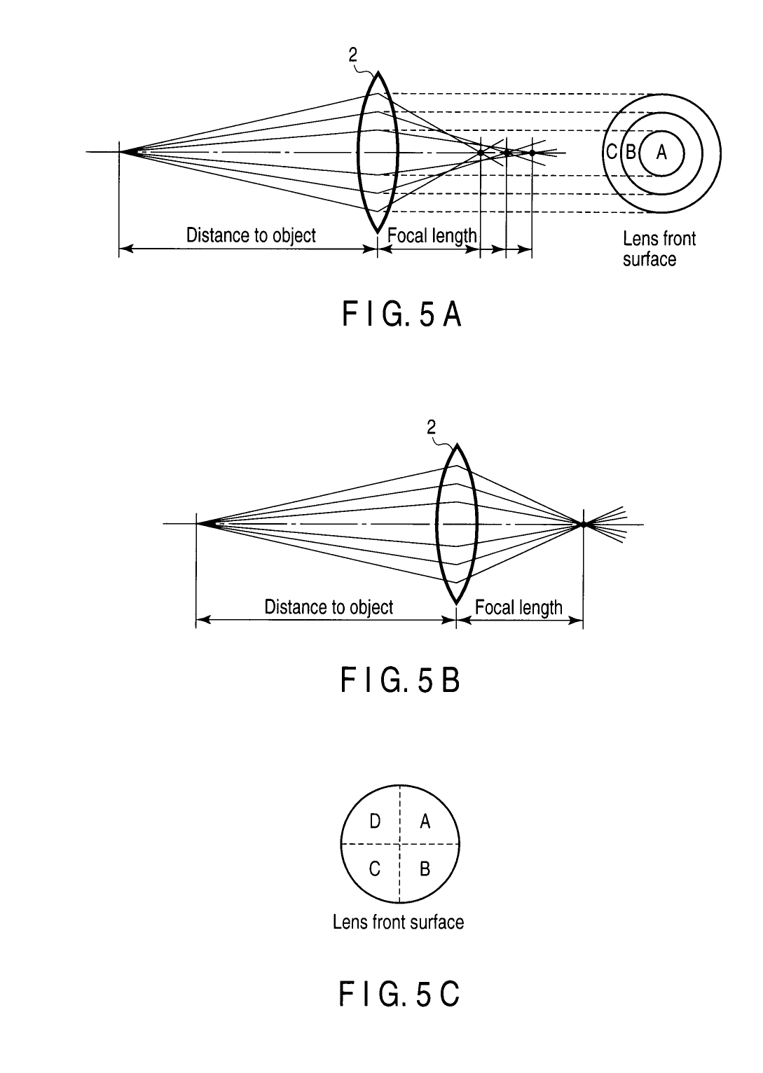

FIG. 5A shows focal properties when a lens having spherical aberration is used for the optical lens 2 depicted in FIG. 1. FIG. 5B shows focal properties of a regular lens, and FIG. 5C shows another example of area division of a spherically aberrant lens.

As shown in FIG. 5B, the regular lens is designed in such a manner that light that has passed through any position of the lens is concentrated on a point having the same focal length. In case of the lens having spherical aberration, focal length differs depending on areas A, B and C of the lens as depicted in FIG. 5A.

It is preferable for planar dimensions of the respective areas A, B and C of the lens to have the same resolution level. Therefore, assuming that a size of the area A is a lens aperture F4.2, a size of the area B is F2.9 to F4.2 and a size of the area C is F2.4 to F2.9, the three areas can have substantially the same resolution levels.

For example, as shown in FIG. 5C, the spherically aberrant lens may be divided into four areas in a cross shape rather than a circular shape. When the number of divisions is increased to four or more, the depth of focus can be further increased.

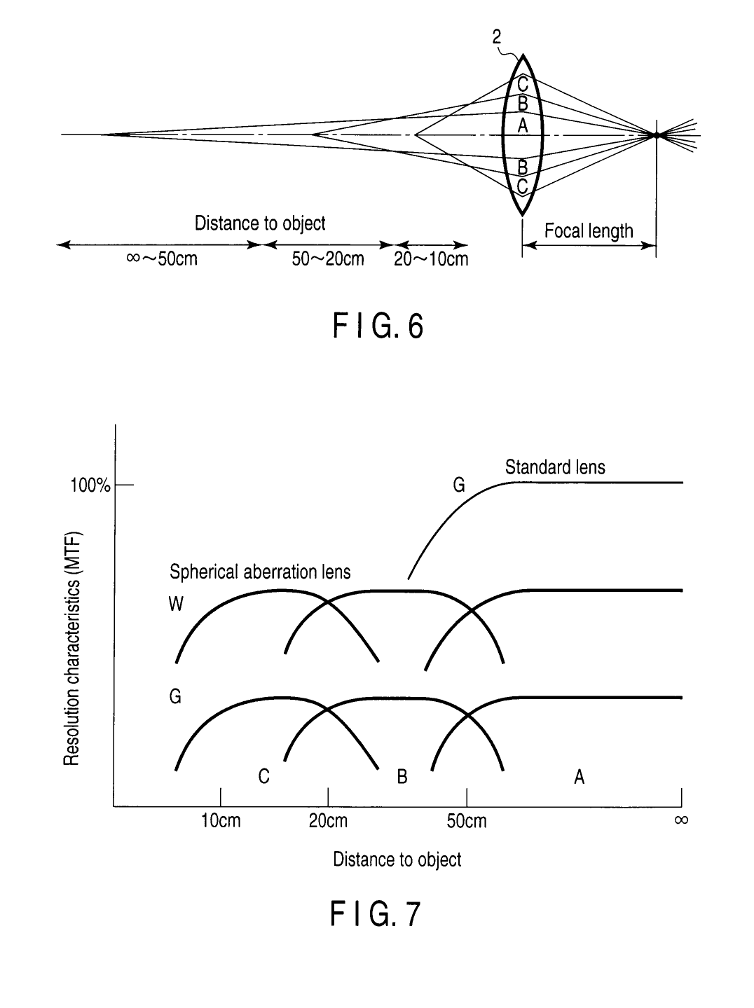

Each of FIGS. 6 and 7 shows a specific design example of the spherically aberrant lens depicted in FIG. 5A.

In the spherically aberrant lens depicted in FIG. 6, focal lengths (distances to a subject) are classified into three zones A, B and C. For example, zone A is designed in such a manner that a distance to an object along which blurring is allowed becomes 50 cm to infinity, zone B is designed in such a manner that the same becomes 20 to 50 cm, and zone C is designed in such a manner that the same becomes 10 to 20 cm.

In the lens design, a lens that a distance to an object is 50 cm to infinity with an aperture F2.4 is first designed. Then, a shape of the lens is changed, and a lens that the distance to the object becomes 20 to 50 cm is designed. Moreover, the shape of the lens is changed, and 3 lenses that the distance to the object becomes 10 to 20 cm are designed. Additionally, the respective areas A, B and C alone are cut out to be combined, and a final lens is formed to bring the spherically aberrant lens to completion.

FIG. 7 shows resolution characteristics of the spherically aberrant lens depicted in FIG. 6.

In a conventional camera module, a standard lens having no spherical aberration is utilized, and a resolution signal is obtained from a pixel G (signal G). Further, a distance to an object is designed to become approximately 50 cm to infinity without blurring. It is assumed that the resolution characteristics modulation transfer function (MTF) in this example is 100%.

When the spherically aberrant lens depicted in FIG. 6 is applied to the optical lens 2, since a level of the resolution characteristics MTF obtained from pixel G with light that has passed through the spherically aberrant lens is lowered to approximately one third since the lens is divided into three areas. Therefore, to obtain regular resolution sensitivity, approximately triple signal level enhancement must be carried out in signal processing. At this time, there is a problem that noise is also enhanced to be approximately tripled.

Thus, in this embodiment, since a signal level that is approximately double a single level of signal G can be obtained by acquiring a resolution signal from the transparent pixel (W), an increase in noise can be suppressed, and the resolution characteristics MTF can be improved.

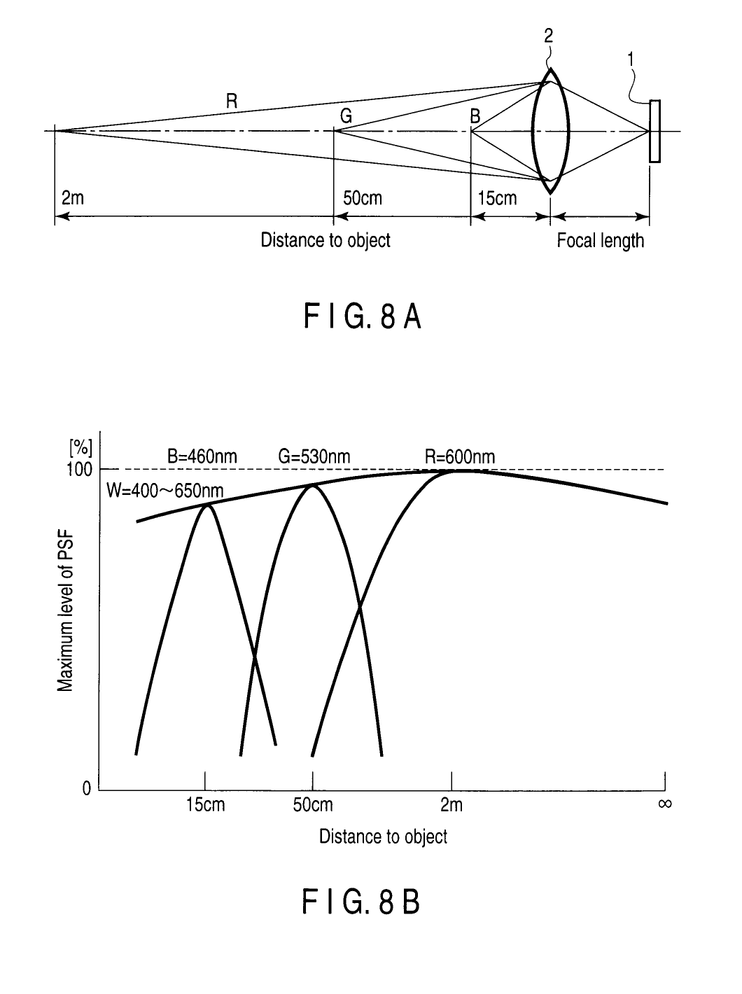

FIG. 8A is a view showing depth of field when a lens having chromatic aberration is used as the optical lens 2 depicted in FIG. 1.

In a regular lens, since the refractive index varies depending on the wavelength of light, chromatic aberration occurs. Therefore, this chromatic aberration is corrected by combining lenses formed of different materials. In this embodiment, this chromatic aberration is positively exploited to increase depth of field.

As shown in FIG. 8A, the lens 2 is designed in such a manner that the sensor chip 1 can be brought into focus when a distance to an object (subject) is 15 cm in regard to signal B having a peak wavelength of 460 nm. Further, the lens 2 is designed by using the chromatic aberration in such a manner that the sensor chip 1 can be brought into focus when the distance to the subject (object) is 50 cm in regard to signal G having a peak wavelength of 530 nm and when the distance to the subject (object) is 2 m in regard to signal R having a peak wavelength of 600 nm.

FIG. 8B is a characteristic view showing a relationship between a distance to the object and a maximum value of the point spread function (PSF) at each peak wavelength B=460 nm, G=530 nm or R=600 nm in the optical lens 2 used in this embodiment. Further, FIG. 8B also shows a change in peak value of the PSF at each single wavelength of 400 to 650 nm in the transparent pixel (W). That is, when the transparent pixel (W) is used, a continuously high PSF of approximately 15 cm to infinity can be obtained. When the transparent pixel (W) is not used, a cross level of the maximum levels of the Puffs at respective B, G and R must be approximately 50%. When the cross level is far lower than 50%, a resolution level at this distance is decreased, and hence a problem of degradation in resolution occurs. On the other hand, when the transparent pixel (W) is utilized, intervals between B, G and R can be expanded, whereby the depth of focus can be further increased.

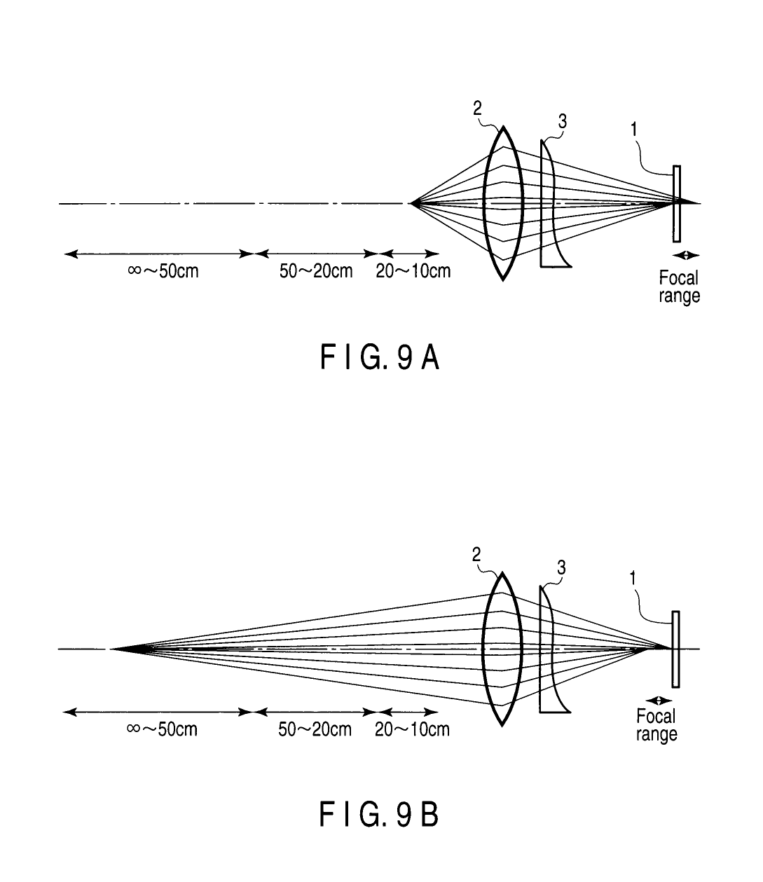

Each of FIGS. 9A and 9B is a view showing depth of field when the phase-shift plate 3 is arranged between the optical lens 2 and the sensor chip 1 depicted in FIG. 1.

As depicted in the drawings, the phase-shift plate 3 is arranged between the lens 2 and the sensor chip 1. The phase-shift plate 3 can change a focal length by modulating the phase of light in accordance with an area through which the light passes. Therefore, the depth of focus can be increased, i.e., the depth of field can be increased as shown in FIGS. 9A and 9B.

For example, as depicted in FIG. 9A, when a distance to the object is 10 to 20 cm, a lower region of the lens can obtain an in-focus signal on a surface of the sensor chip 1 as depicted in FIG. 9A. As depicted in FIG. 9B, when a distance to the object is 50 cm to infinity, an upper region of the lens 2 can obtain the in-focus signal on the surface of the sensor chip 1. When a distance to the object is 20 to 50 cm, a central region of the lens 2 can obtain the in-focus signal on the surface of the sensor chip 1.

As the phase-shift plate 3, one having irregularities formed into a reticular pattern or one having a transparent thin film having a different refractive index disposed to a part of a plane parallel glass plate is used. Further, as the phase-shift plate 3, a crystal plate, a ventricular, a Christiansen filter and others can be also utilized.

It is to be noted that the phase-shift plate means a transparent plate that is inserted into an optical system to impart to light a phase difference. Basically, there are the following two types: (1) the first one is a crystal plate which allows linear polarization components vibrating in main axial directions orthogonal to each other to pass therethrough and imparts a phase difference required for these two components, there being a half-wavelength plate, a quarter-wavelength plate and others; (2) the second one has an isotropic transparent thin film having a refractive index n and a thickness d provided on a part of a plane parallel glass plate. A phase difference is provided between light components that pass through a portion having the transparent thin film and a portion having no transparent thin film.

As described above, in the first embodiment, the depth of field can be increased by using an optical lens having spherical or chromatic aberration or arranging the phase-shift plate between the optical lens and the sensor chip. Furthermore, as a countermeasure for the resolution signal reduced because of an increase in depth of field, a resolution signal having a high signal level and an improved signal-to-noise (SN) ratio can be generated by utilizing signal W obtained from light having passed through the transparent filter to acquire the resolution signal.

According to the first embodiment, since the depth of field can be increased, an autofocus (AF) mechanism is no longer necessary. As an effect, a height of the camera module can be decreased, and a thin mobile phone equipped with a camera can be easily manufactured. Moreover, since the AF mechanism is no longer required, a camera having resistance to shock can be provided. Additionally, since a time lag is generated in an AF operation, photo opportunities may be highly possibly lost, but the AF is not used in this embodiment, whereby a camera that can readily take photo opportunities without producing a time lag can be provided.

Additionally, although there is a camera having a macro changeover function for a fixed-focus camera, a macro changeover switch is reversed in such a camera, and failures that a blurry image is taken often occur. However, since the changeover is not required in this embodiment, failures of taking a blurry image do not occur. Additionally, since the mechanism, e.g., macro changeover is no longer necessary, a product cost can be decreased. Further, since design and manufacture of the lens can be facilitated and the same material, structure and others as those of a standard lens can be utilized for formation, the product cost is not increased. Furthermore, a circuit scale of the signal processing circuit can be reduced, the small and inexpensive solid-state imaging device and camera module can be provided.

### Second Embodiment

A solid-state imaging device according to a second embodiment will now be described.

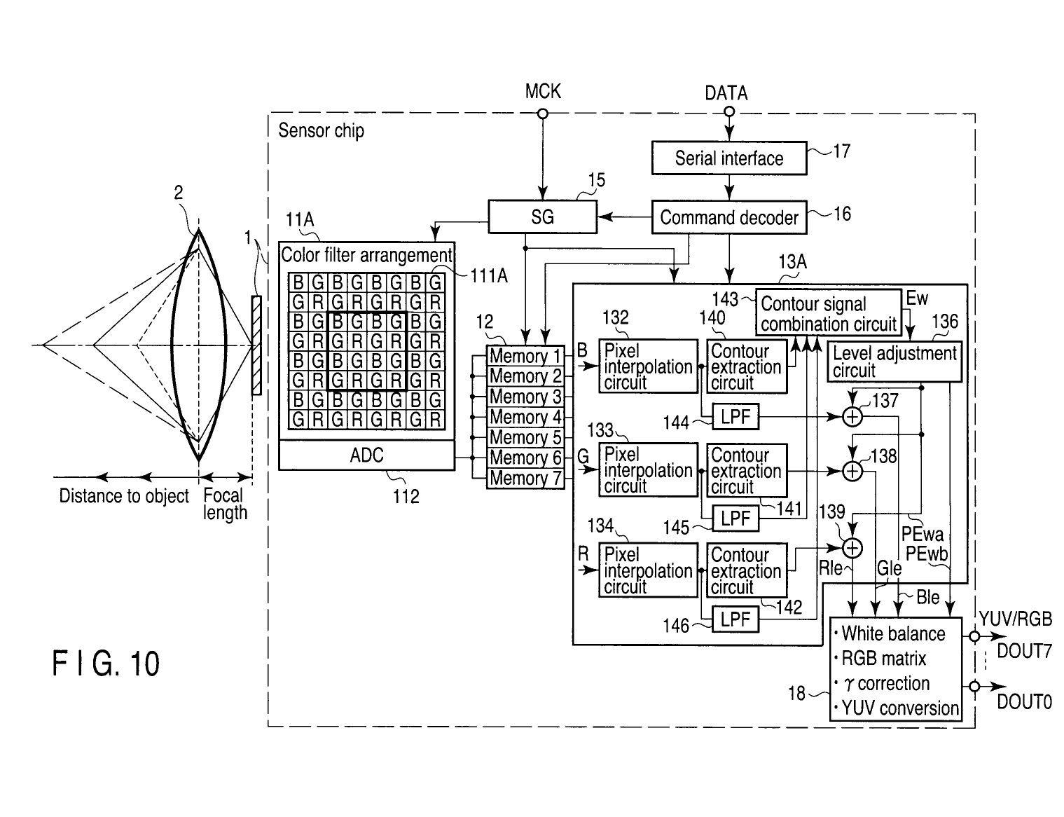

FIG. 10 is a view showing an outline configuration of a solid-state imaging device using a CMOS image sensor according to the second embodiment.

This solid-state imaging device is constituted of an optical lens 2 which condenses optical information of a subject and a sensor chip 1 which converts a light signal condensed by the optical lens 2 into an electrical signal and outputs the converted signal as a digital image signal. A spherically or chromatically aberrant lens is used as the optical lens 2 to increase depth of field. Further, an optical mask (e.g., a phase-shift plate) is arranged between the optical lens 2 and the sensor chip 1 to increase the depth of field.

The sensor chip 1 according to this embodiment is different from the configuration according to the first embodiment in that a color arrangement of color filters in a pixel array 111A in a sensor unit 11A is a general Bayer arrangement in which two pixels G, one pixel B and one pixel R are arranged in a basic 2×2 pixel arrangement.

With such a change in color arrangement of the color filters, a part of a resolution restoration circuit 13A is also changed. That is, in the resolution storage circuit 13A according to this embodiment, since signals W are not input, the pixel interpolation circuit 131 and the contour extraction circuit 135 for signals W provided in the first embodiment are omitted.

Furthermore, contour signals obtained from a contour extraction circuit 140 for signals B, a contour extraction circuit 141 for signals G and a contour extraction circuit 142 for signals R are combined with each other by a contour signal combination circuit 143 to generate a contour signal Ew. Moreover, the contour signal Ew has its level properly adjusted by a level adjustment circuit 136, and the contour signals obtained thereby are output as contour signals PEwa and PEwb. Additionally, low-pass filters (LPFs) 144, 145 and 146 are added in such a manner that respective signals R, G and B output from pixel interpolation circuits 132, 133 and 134 can have the same band. Contour signal PEwa is supplied to a plurality of addition circuits 137 to 139. In the addition circuits 137 to 139, B, G and R signals output from a plurality of LPFs 144 to 146 and limited to low frequencies are added to level-adjusted contour signal PEwa. Signals BLe, Gle and Rle obtained by the addition circuits 137 to 139 and level-adjusted contour signal PEwb are supplied to a signal processing circuit 18.

In the signal processing circuit 18, the received signals are utilized to perform processing such as general white balance adjustment, color adjustment (RGB matrix), γ correction or YUV conversion, and the processing signals are output as digital signals DOUTO to DOUT7 each having a YUV signal format or an RGB signal format. It is to be noted that the contour signal adjusted by the level adjustment circuit 136 can be added to a luminance signal (signal Y) in the subsequent signal processing circuit 18. The signal processing performed by the signal processing circuit 18 was described above with reference to FIG. 26.

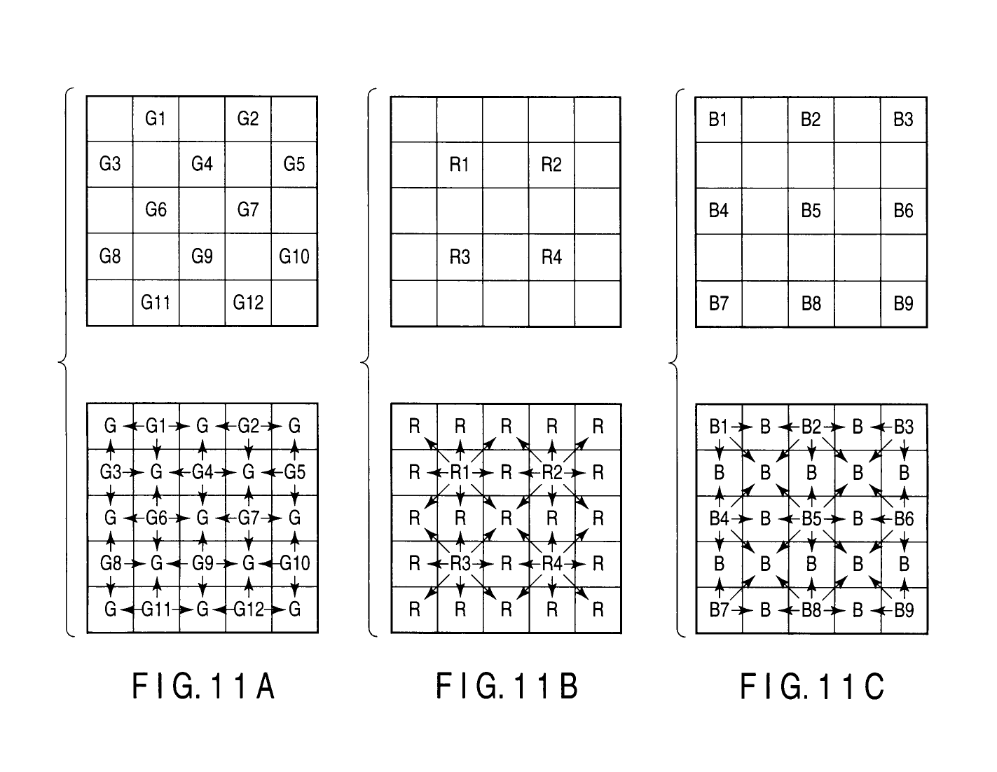

Each of FIGS. 11A, 11B and 11C is a view showing how interpolation processing for each signal G, R or B is performed in the pixel interpolation circuits 132 to 134 in FIG. 10. It is to be noted that an upper side of each of FIGS. 11A, 11B and 11C shows signals before the interpolation and a lower side of the same shows signals after the interpolation.

In FIGS. 11A, 11B and 11C, the interpolation is performed with an average value of signals of two pixels when the number of arrows is two, the interpolation is performed with an average value of signals of three pixels when the number of arrows is three, and the interpolation is performed with an average value of signals of four pixels when the number of arrows is four.

For example, paying attention to FIG. 11A, a signal G at a position surrounded by signals G1, G3, G4 and G6 provided at four positions is subjected to the interpolation with an average value of signals G1, G3, G4 and G6 at the four positions. Furthermore, paying attention to FIG. 11C, a signal B placed at the center of signals B1, B2, B4 and B5 provided at four positions is subjected to the interpolation with an average value of signals B1, B2, B4 and B5 at the four positions. Moreover, a signal B sandwiched between signals B1 and B2 provided at two positions is subjected to the interpolation with an average value of signals B1 and B2 at the two positions.

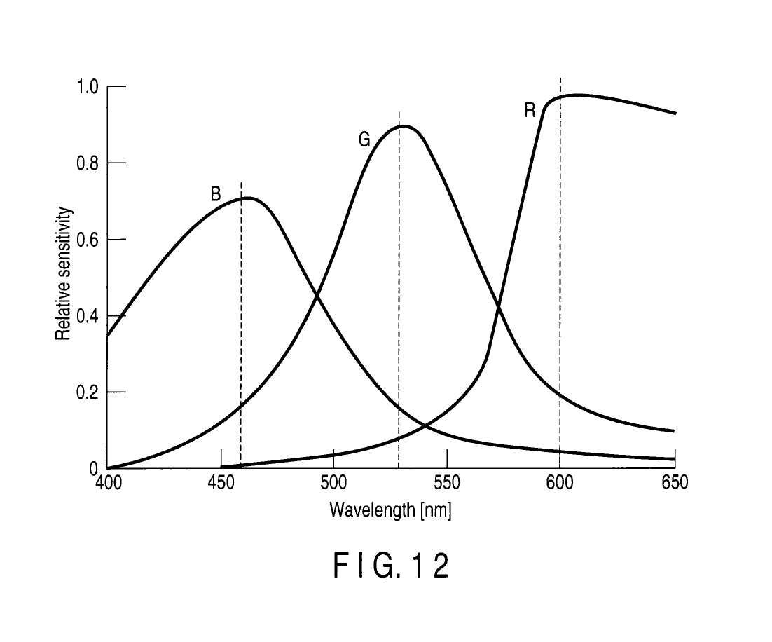

FIG. 12 is a characteristic view showing spectral sensitivity characteristics in the solid-state imaging device according to the second embodiment. As shown in the drawing, a peak of spectral characteristics of signal B is 460 nm, a peak of spectral characteristics of signal G is 530 nm, and a peak of spectral characteristics of signal R is 600 nm.

In the second embodiment, as in the first embodiment, depth of field can be increased by using an optical lens having spherical or chromatic aberration or arranging a phase-shift plate between the optical lens and a sensor chip. Additionally, as a countermeasure for a resolution signal reduced because of an increase in depth of field, a resolution signal having a high signal level and an improved SN ratio can be generated by utilizing each signal obtained from light having passed through the filter B, G or R to acquire the resolution signal.

Other structures and effects in the second embodiment are the same as those in the first embodiment, thereby omitting a description thereof.

### Third Embodiment

A solid-state imaging device according to a third embodiment will now be described.

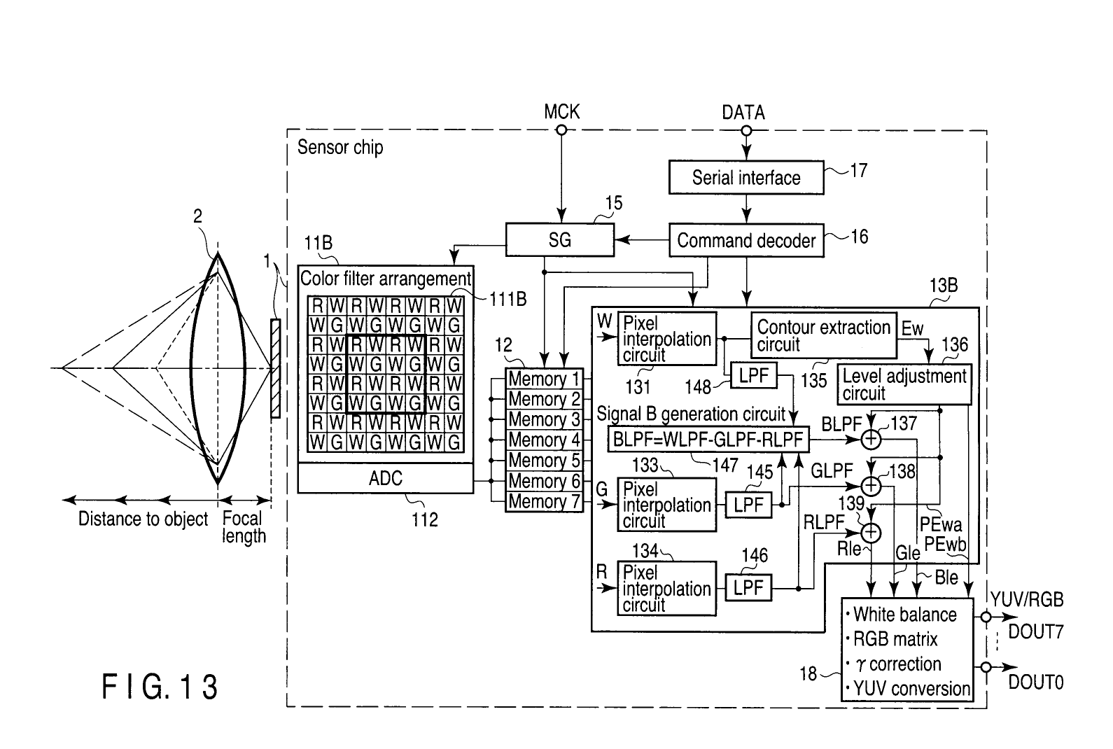

FIG. 13 is a view showing an outline configuration of a solid-state imaging device using a CMOS image sensor according to the third embodiment.

This solid-state imaging device is constituted of an optical lens 2 which condenses optical information of a subject and a sensor chip 1 which converts a light signal condensed by the optical lens 2 into an electrical signal to output a digital image signal. A spherically or chromatically aberrant lens is utilized as the optical lens 2 to increase depth of field. Further, an optical mask (e.g., a phase-shift plate) is arranged between the optical lens 2 and the sensor chip 1 to increase the depth of field.

The sensor chip 1 according to this embodiment is different from the configuration according to the first embodiment in that two pixels W having a checkered pattern, one pixel G and one pixel R are arranged in a basic 2×2 pixel arrangement as a color arrangement of color filters in a pixel array 111B of a sensor unit 11B. Based on adoption of such color filters, outputs of signals R are doubled, i.e., four outputs in a 4×4 pixel arrangement in the third embodiment as compared with the sensor unit 11 in the first embodiment. Since a resolution restoration circuit 13B has no signals B, it includes a signal B generation circuit 147 which generates signals B. Since the number of pixels W, the number of pixels G and the number of pixels R are different from each other, low-pass filters (LPFs) 148, 145 and 146 are included to provide the same signal band. Furthermore, in the signal B generation circuit 147, a signal BLPF as a signal B is generated from signals WLPF, GLPF and RLPF as signals W, G and R having passed through the low-pass filters (LPFs) based on BLPF=WLPF−GLPU−RLPF.

A resolution is restored by adding the respective signals BLPF, GLPF and RLPF as B, G and R to level-adjusted contour signal PEwa.

Signals added by addition circuits 137 to 139 are supplied to a subsequent signal processing circuit 18. The signal processing circuit 18 uses the received signals to perform processing such as general white balance adjustment, color adjustment (RGB matrix), y correction or YUV conversion and outputs the converted signals as digital signals DOUT0 to DOUT7 each having a YUV signal format or an RGB signal format. It is to be noted that contour signal PEwb adjusted by the level adjustment circuit 136 can be added to a luminance signal (signal Y) in the subsequent signal processing circuit 18. The signal processing performed by the signal processing circuit 18 was described above with reference to FIG. 26.

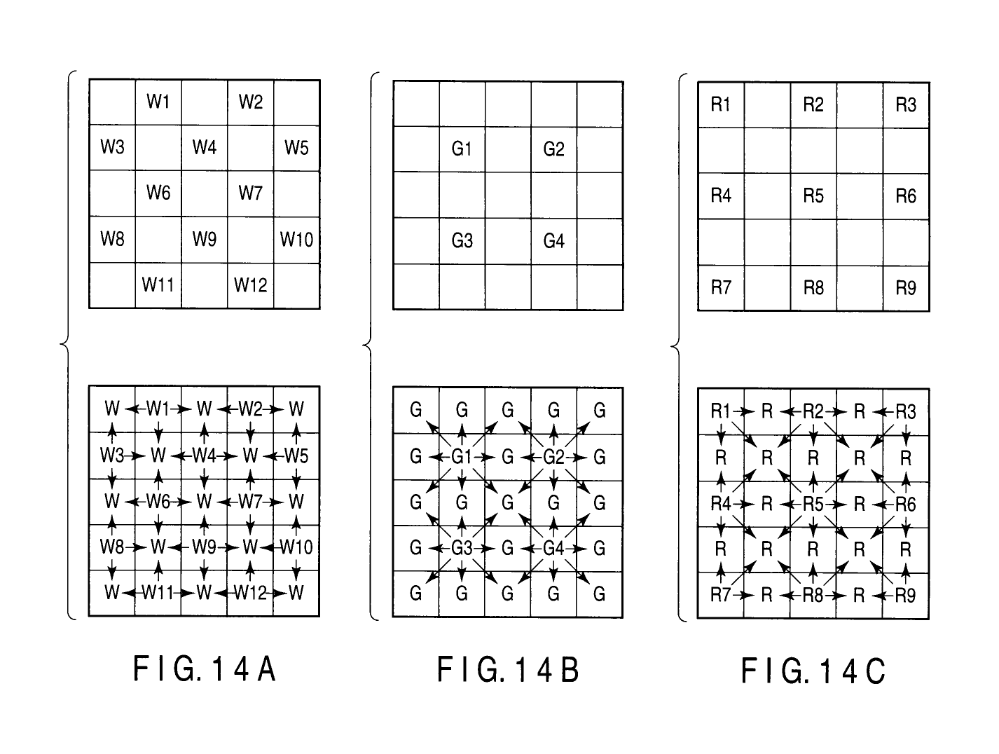

Each of FIGS. 14A, 14B and 14C is a view showing how interpolation processing for each signal W, G or R is performed in pixel interpolation circuits 131, 133 and 134 depicted in FIG. 13. It is to be noted that an upper side of each of FIGS. 14A, 14B and 14C shows signals before the interpolation and a lower side of the same shows signals after the interpolations.

In each of FIGS. 14A, 14B and 14C, the interpolation is performed with an average value of signals of two pixels when the number of arrows is two, the interpolation is performed with an average value of signals of three pixels when the number of arrows is three, and the interpolation is performed with an average value of signals of four pixels when the number of arrows is four.

For example, paying attention to FIG. 14A, a signal W at a position surrounded by signals W1, W3, W4 and W6 provided at four positions is subjected to the interpolation with an average value of signals W1, W3, W4 and W6 at the four positions. Furthermore, paying attention to FIG. 14C, a signal R placed at the center of signals R1, R2, R4 and R5 provided at four positions is subjected to the interpolation with an average value of signals R1, R2, R4 and R5 at the four positions. Moreover, a signal R sandwiched between signals R1 and R2 provided at two positions is subjected to the interpolation with an average value of signals R1 and R2 at the two positions.

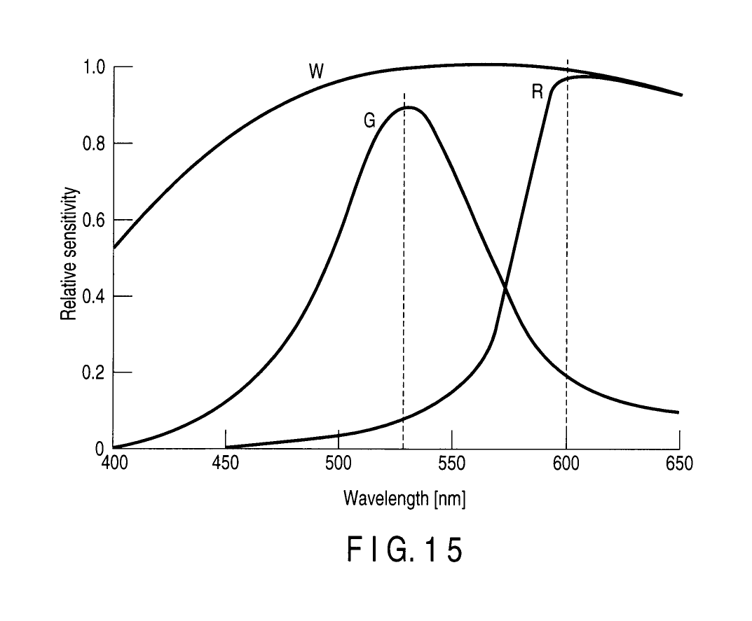

FIG. 15 is a characteristic view showing spectral sensitivity characteristics in the solid-state imaging device according to the third embodiment. In this embodiment, since there is no pixel B, there are three types of spectral characteristic curves W, G and R. A peak of spectral characteristics of signal G is 530 nm, and a peak of spectral characteristics of signal R is 600 nm. Signal W has high sensitivity because of a transparent layer and has gentle characteristics from 400 to 650 nm.

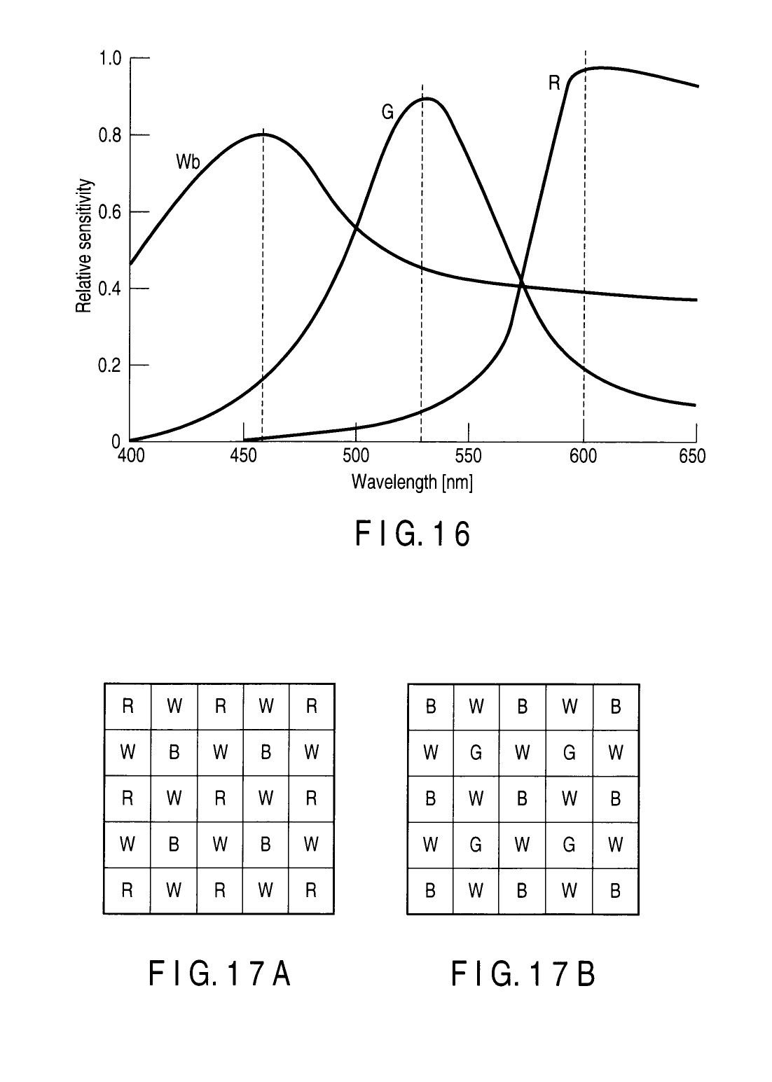

FIG. 16 is a characteristic view showing a modification of the spectral sensitivity of characteristics in the third embodiment. When spectral characteristics Wb of pixel W are formed as depicted in FIG. 16, an SN ratio of signal B can be improved. Signal B is calculated based on B=W−G−R. Therefore, in case of the spectral characteristics of pixel W depicted in FIG. 15, larger signals G and R must be subjected to subtraction. However, in this modification, the sensitivity in regions G and R of signal W is lowered, and a signal Wb is formed as depicted in FIG. 16. As a result, a subtraction amount of signal G and signal R at the time of calculating signal B can be reduced to approximately a half. Moreover, since signal Wb has the high sensitivity in the region of signal B, color reproducibility of the generated signal B can be also improved.

Such spectral characteristics of signal Wb can be realized by forming the thin color filter of B having the spectral characteristics of signal B shown in FIG. 12 or by reducing a pigment material of B and increasing a polymer material since the pigment material of B and the polymer material are mixed in the color filter of B.

In the third embodiment, as in the first embodiment, the depth of field can be increased by using the optical lens having spherical or chromatic aberration or by arranging the phase-shift plate between the optical lens and the sensor chip. Additionally, as a countermeasure for a resolution signal reduced because of an increase in depth of field, a resolution signal having a high level and an excellent SN ratio can be generated by using signal W obtained from light having passed through the transparent filter to acquire the resolution signal. Further, the SN ratio and the color reproducibility of signal B to be generated can be improved by reducing transparency of the transparent filter in a G wavelength region and an R wavelength region.

Other structures and effects in the third embodiments are the same as those in the first embodiment, thereby omitting a description thereof.

### Fourth Embodiment

A solid-state imaging device according to a fourth embodiment will now be described. In the fourth embodiment, an example that the color arrangement of the color filters in the sensor unit according to the third embodiment is changed will be explained.

Each of FIGS. 17A and 17B is a view showing a color arrangement of color filters of a sensor unit in the solid-state imaging device according to the fourth embodiment.

In FIG. 17A, as the color arrangement of the color filters in the sensor unit, two pixels W having a checkered pattern, one pixel R and one pixel B are arranged in a basic 2×2 pixel arrangement. This color arrangement has no signal G, signal G is calculated based on G=W−B−R.

Furthermore, in FIG. 17B, as a color arrangement of the color filters, two pixels W having a checkered pattern, one pixel G and one pixel B are arranged in a basic 2×2 pixel arrangement. Since this color arrangement has no signal R, signal R is calculated based on R=W−B−G.

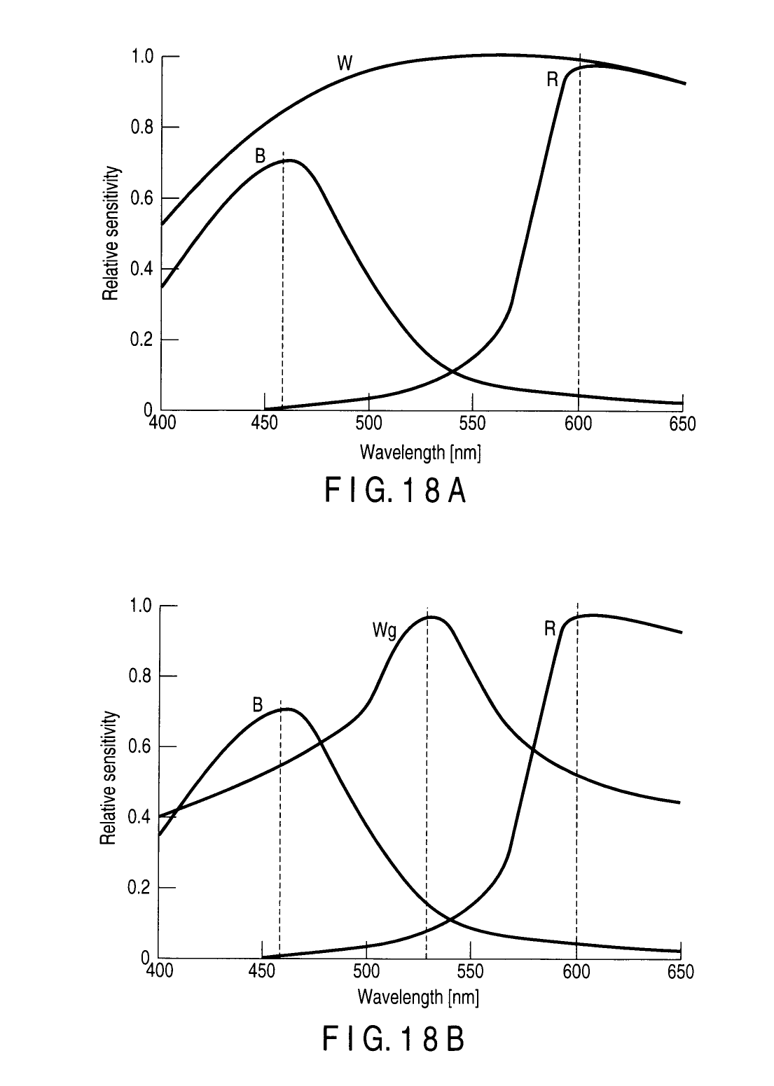

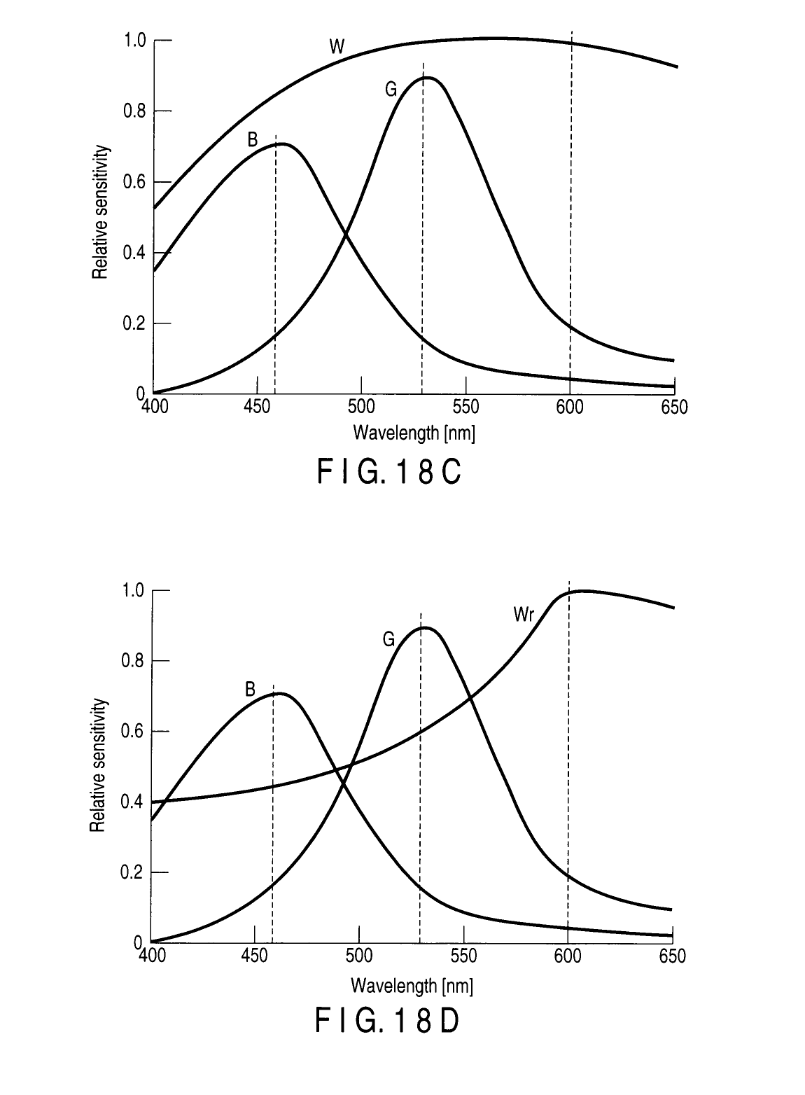

FIG. 18A is a characteristic view showing spectral sensitivity characteristics of a solid-state imaging device having the color filters depicted in FIG. 17A.

Since the color filters depicted in FIG. 17A have no pixel G, there are three types of spectral characteristic curves W, B and R as shown in FIG. 18A. A peak of spectral characteristics of signal B is 460 nm, and a peak of spectral characteristics of signal R is 600 nm. Signal W has high sensitivity because of a transparent layer and has gentle characteristics from 400 to 650 nm.

FIG. 18B is a characteristic view showing a modification of spectral sensitivity characteristics of a solid-state imaging device having the color filters depicted in FIG. 17A.

An SN ratio of signal G can be improved by forming spectral characteristics Wg of pixel W as depicted in FIG. 18B. Signal G is calculated based on G=W−B−R. Therefore, in the spectral characteristics of pixel W depicted in FIG. 18A, larger signals B and R must be subjected to subtraction. However, in this modification, the sensitivity of signal W in regions B and R is reduced to form a signal Wg as depicted in FIG. 18B. As a result, a subtraction amount of signal

B and signal R at the time of calculating signal G can be reduced to approximately half. Further, since signal Wg has high sensitivity in a region of signal G, color reproducibility of the generated signal G can be improved.

Such spectral characteristics of signal Wg can be realized by forming a thin color filter of G having conventional spectral characteristics of signal G or by reducing a pigment material of G and increasing a polymer material since the pigment material of G and the polymer material are mixed in the color filter of G.

FIG. 18C is a characteristic view showing spectral sensitivity characteristics of a solid-state imaging device having the color filters depicted in FIG. 17B.

Since the color filter shown in FIG. 17B has no pixel R, there are three types of spectral characteristic curves W, B and G as shown in FIG. 18C. A peak of spectral characteristics of signal B is 460 nm, and a peak of spectral characteristics of signal G is 530 nm. Signal W has high sensitivity because of a transparent layer and has gentle characteristics from 400 to 650 nm.

FIG. 18D is a characteristic view showing a modification of spectral sensitivity characteristics of a solid-state imaging device having the color filters depicted in FIG. 17B.

An SN ratio of signal R can be improved by forming spectral characteristics Wr of pixel W as depicted in FIG. 18D. Signal R is calculated based on R=W−B−G. Therefore, in the spectral characteristics of pixel W shown in FIG. 18C, larger signals B and G must be subjected to subtraction. However, in this modification, the sensitivity of signal W in regions B and G is reduced to form a signal Wr as depicted in FIG. 18D. As a result, a subtraction amount of signal B and signal G at the time of calculating signal R can be reduced to approximately half. Further, since signal Wr has high sensitivity in a region of signal R, color reproducibility of the generated signal R can be also improved.

Such spectral characteristics of signal Wr can be realized by forming a thin color filter of R having conventional spectral characteristics of signal R or by reducing a pigment material of R and increasing a polymer material since the pigment material of R and the polymer material are mixed in the color filter of R.

In the fourth embodiment, as in the first embodiment, depth of field can be increased by using an optical lens having spherical or chromatic aberration or arranging a phase-shift plate between the optical lens and a sensor chip. Furthermore, as a countermeasure for a resolution signal reduced because of an increase in depth of field, a resolution signal having a high level and an excellent SN ratio can be generated by using a signal W obtained from light having passed through the transparent filter to acquire the resolution signal.

Other structures and effects according to the fourth embodiment are equal to those according to the first embodiment, thereby omitting a description thereof.

### Fifth Embodiment

A solid-state imaging device according to a fifth embodiment will now be described.

A pixel W can obtain signals that are double signals of a pixel G. Therefore, there is a problem that pixel W is saturated quickly. As a countermeasure, there is a method of improving the saturation of pixel W based on a special operation such as a wide dynamic range (WDR).

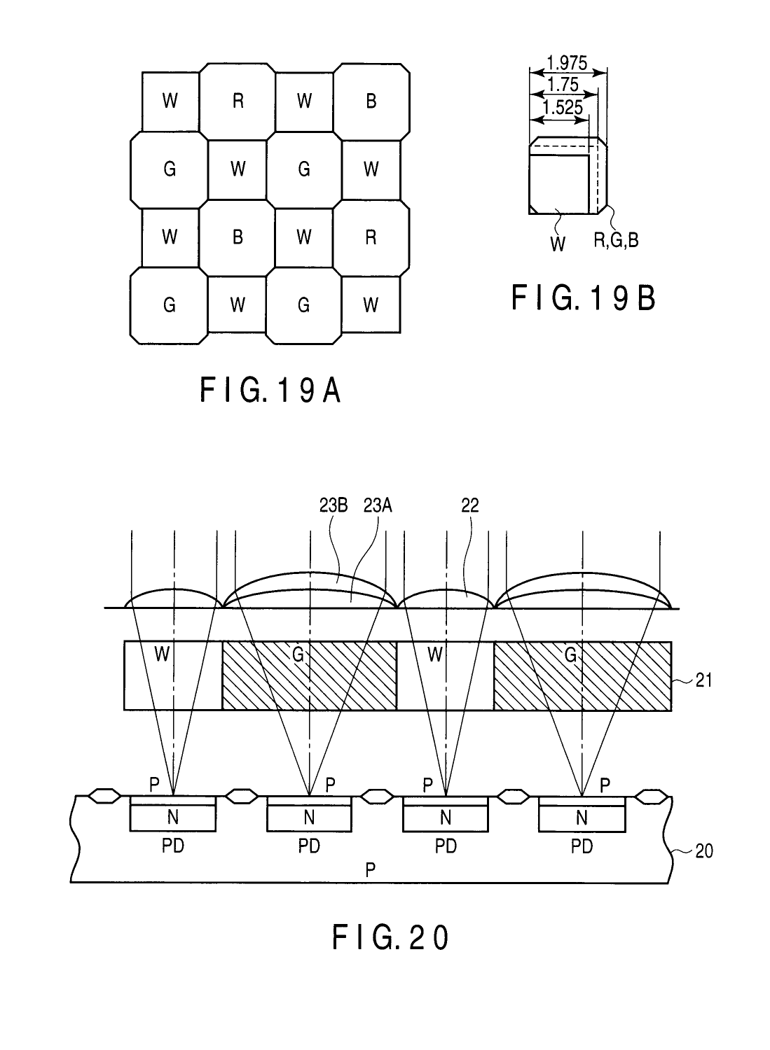

When the WDR is not used, applying pixel sizes depicted in FIGS. 19A and 19B is effective means. FIG. 19A shows a 4×4 pixel arrangement of color filters WRGB. In this pixel arrangement, an area of each pixel W arranged in a checkered pattern is reduced, and areas of other pixels R, G and B are relatively increased with respect to pixel W.

For example, as shown in FIG. 19B, when pixel W is formed to have a size of 1.525 μm and the other pixels R, G and B are formed to have a size of 1.975 μm with respect to a regular pixel having a size of 1.75 μm, the sensitivity of pixel W can be relatively reduced to approximately 60% with respect to those of the other pixels R, G and B. The size of 1.75 μm means a square which has each side having a length of 1.75 μm.

Since an area of pixel W is reduced and each of pixels R, G and B can be thereby increased to have the size of 1.975 (=1.75+0.225) μm, high sensitivity that is 1.27-fold of that of the conventional pixel having the size of 1.75 μm can be realized.

FIG. 20 is a cross-sectional view of a sensor unit associated with pixels WGWG arranged in a horizontal direction. A color filter 21 is arranged above a silicon semiconductor substrate 20 having photodiodes (PDs) formed thereon, and microlenses 22, 23A and 23B are arranged above the color filter 21.

An area of a light receiving surface of the photodiode (PD) does not vary with respect to pixels W and G and pixels R and B (not shown). This area may be subjected to size optimization in accordance with a signal charge amount which is produced when a standard color temperature is assumed.

As shown in FIG. 20, areas of the microlens 22 and the color filter of W are set to be smaller than those of the color filter of G (areas of the microlenses 23A and 23B and the color filter of G) in accordance with each pixel W depicted in the plan view of FIG. 19A. That is, areas of pixels W having high sensitivity are reduced, and areas of pixels G or R and B having lower sensitivity than that of pixels W are increased.

Each pixel W and each pixel G can have the same signal amount at a standard color temperature, e.g., 5500 K, by differentiating the areas in this manner. The high sensitivity of the sensor unit can be realized by utilizing merits of the high sensitivity of each pixel W to reduce an incidence area with respect to pixel W and increase the areas of the other pixels R, G and B.

In regard to curvatures of the microlenses, the curvature of the microlens 23B associated with pixels R, G and B each having a large area is increased, and the curvature of the microlens 22 associated with pixel W having a small area is reduced. The curvatures of the microlenses can be changed by forming the microlenses, i.e., forming the microlens 22 in one coating process for pixel W and forming the microlenses 23A and 23B for pixels R, G and B each having a large area in two or more coating processes.

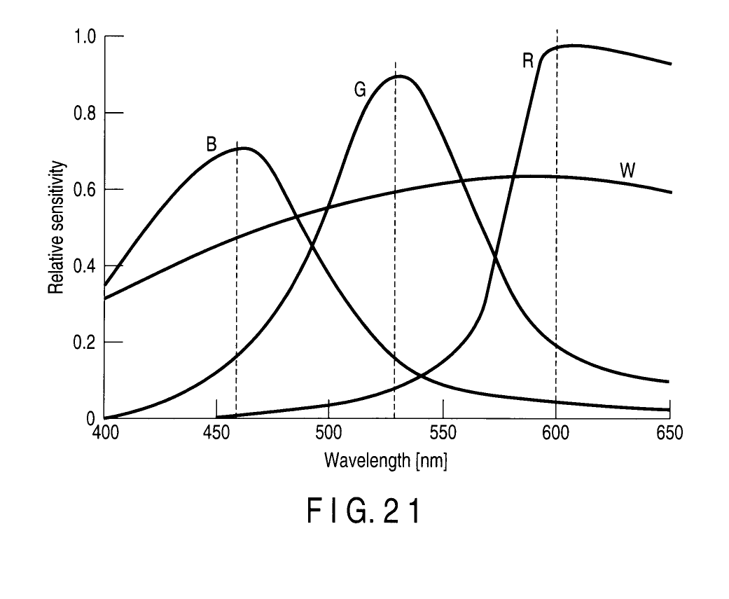

FIG. 21 shows spectral characteristics when the color filters WRGB depicted in FIG. 19A are used. It can be understood that a signal level of pixel W is small and signals of pixels R, G and B are thereby increased. Since an incident signal amount for pixel W is reduced, the broad uplift of levels (color mixture) of signals R and G each having a wavelength of 550 nm or greater is decreased. As a result, a color matrix coefficient for an improvement in color reproducibility can be reduced, thereby decreasing degradation in the SN ratio.

As described above, signal W obtained from the color filter of W (transparent) which is used for realization of high sensitivity has sensitivity that is approximately double that of signal G. Therefore, the color mixture grows because of a problem that a signal balance is disrupted or leak from pixel W, and the color matrix coefficient for the improvement in color reproducibility is increased, thus leading to the problem that the SN ratio is degraded.

However, according to this embodiment, the SN ratio of each color signal can be improved and pixels W and G can be adjusted to have the same signal level by reducing the area of each pixel W having the high sensitivity and increasing the areas of the other pixels R, G and B. Consequently, the color matrix coefficient can be reduced, thereby avoiding the degradation in SN ratio.

That is, since the color mixture that occurs in the silicon substrate having the photodiodes formed thereto can be decreased by reducing the area of each pixel W, the degradation in SN ratio due to the color matrix processing can be lowered. Furthermore, since the sensitivity is increased by enlarging the areas of pixels R, G and B to which effective light enters, thereby improving the SN ratio.

Moreover, as a method of reducing the sensitivity of each pixel W, when gray is realized by materials of the color filters such as R, G, B and others, the sensitivity can be reduced. Additionally, the materials of the color filters are not restricted to R, G and B.

### Sixth Embodiment

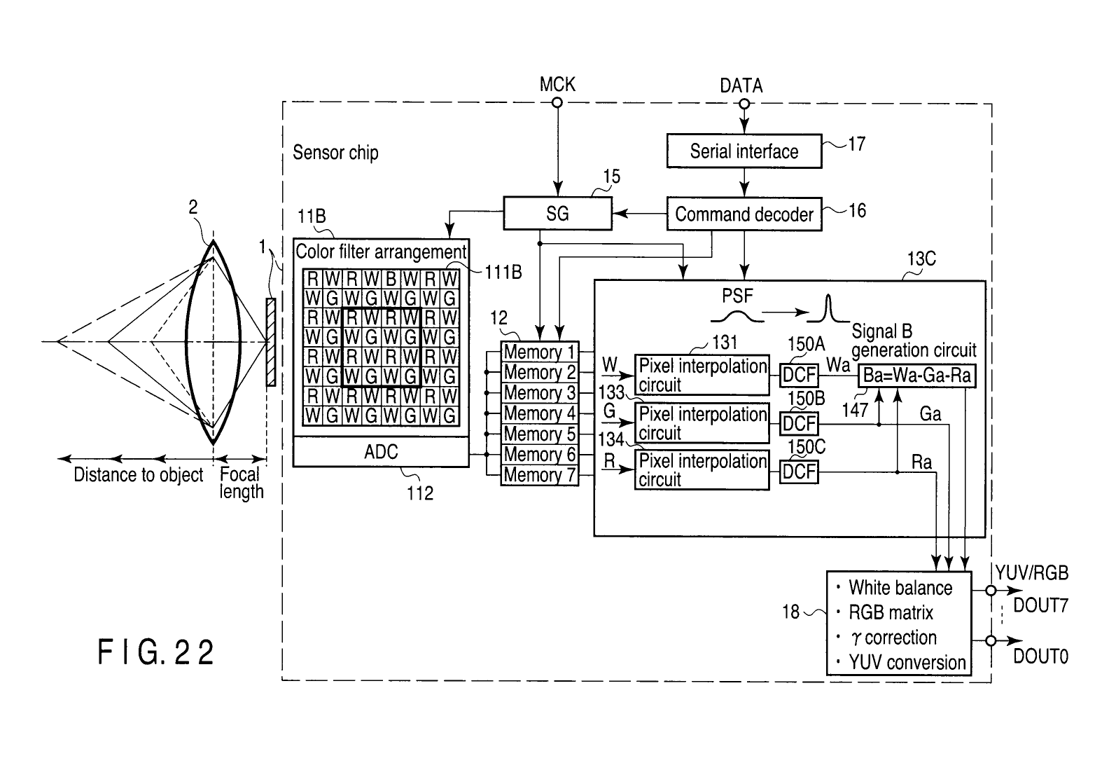

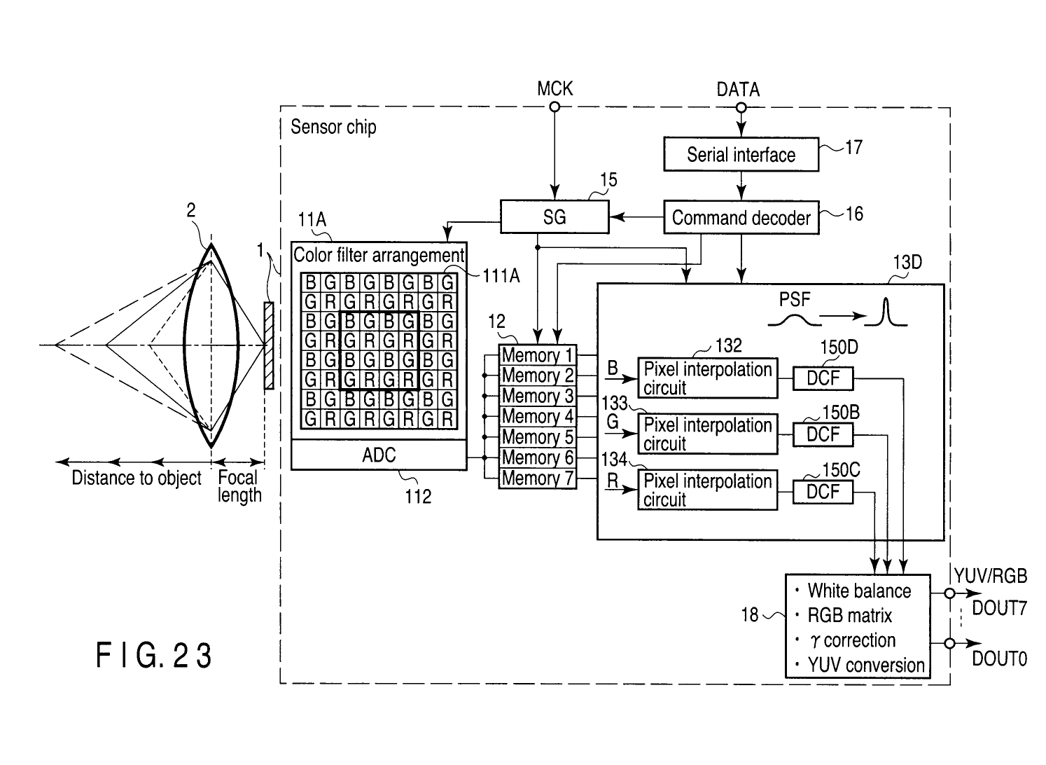

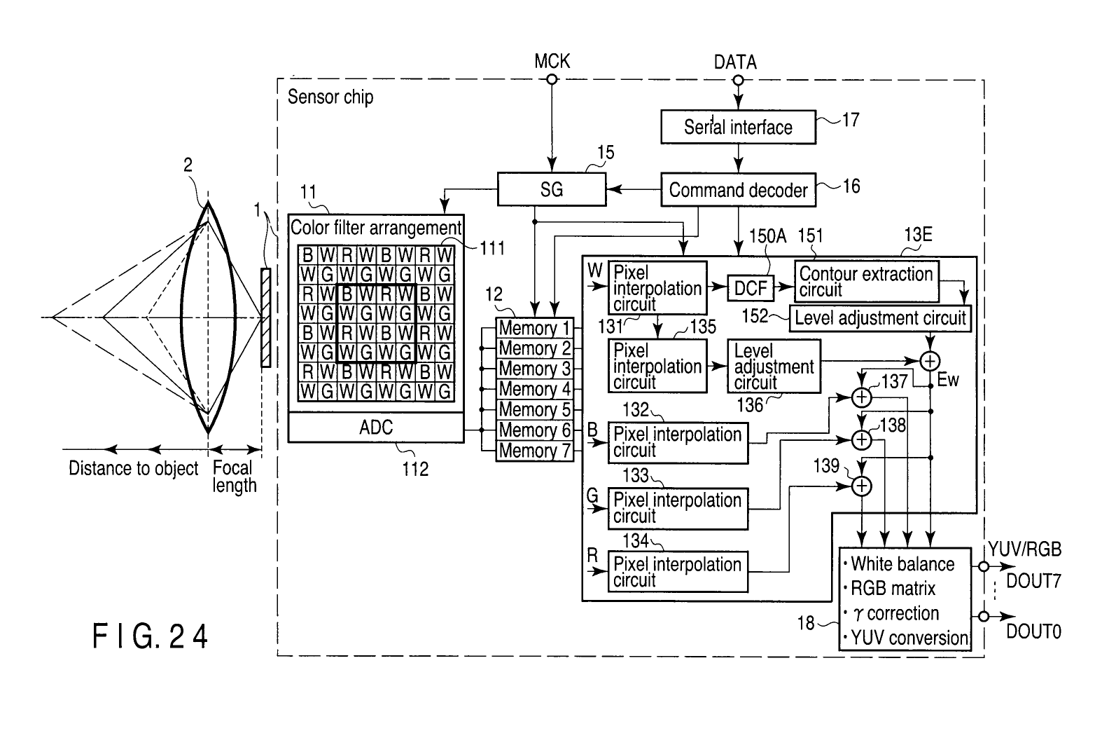

A modification of the resolution restoration circuits in the first, second and third embodiments will now be described as a sixth embodiment. FIG. 22 shows a modification of the resolution restoration circuit in the third embodiment, FIG. 23 shows a modification of the resolution restoration circuit in the second embodiment, and FIG. 24 shows a modification of the resolution restoration circuit in the first embodiment.

FIG. 22 shows a modification of the resolution restoration circuit depicted in FIG. 13. In this modification, deconvolution conversion filters (DCFs) 150A, 150B and 150C for the point spread function (PSF) of an optical lens are used for a resolution restoration circuit 13C. The PSF obtained from the optical lens having an increased depth of focus draws a gentle curve as shown in FIG. 22. Here, when the obtained deconvolution conversion filters (DCFs) 150A, 150B and 150C are utilized to calculate respective signals W, G and R, a precipitous PSF curve can be obtained as an output. That is, an image as an result of decreasing blur in a blurry image can be obtained. A signal B can be obtained by performing a calculation Ba=Wa−Ga−Ra in a signal B generation circuit 146 following a pixel interpolation circuit 131.

FIG. 23 shows a modification of the resolution restoration circuit depicted in FIG. 10. In this modification, DCFs 150D, 150B and 150C included in a resolution restoration circuit 13D are utilized to improve an out-of-focus PSF to a precipitous PSF. DCFs 150D, 150B and 150C process signals subjected to pixel interpolation processing in pixel interpolation circuits 132, 133 and 134 and output the processed signals to a subsequent signal processing circuit 18. FIG. 24 shows a modification of the resolution restoration circuit depicted in FIG. 1. A resolution restoration circuit 13E according to this modification uses a DCF 150A to extract a resolution signal of a signal W obtained from a pixel W. In general, making uniform a PSF of an optical lens on an entire lens surface is difficult. In particular, the PSF greatly spreads as distanced from the center. Therefore, when optimum DCF processing is carried out on the entire lens surface, many parameters for the DCF are required, and hence a circuit scale increases.

Thus, DCF processing that improves the minimum spread is uniformly performed. A contour extraction circuit 151 executes contour extraction processing from a signal processed by DCF 150A, and a level adjustment circuit 152 performs level adjustment to provide an edge signal in a high frequency band.

Further, the following processing is effected to extract an edge signal in an intermediate frequency band of a signal W. A contour extraction circuit 135 performs contour extraction from a signal obtained by interpolating signal W by a pixel interpolation circuit 131 for pixels W, and the level adjustment circuit 136 carries out level adjustment to extract the edge signal in the intermediate frequency band.

Furthermore, adding the two edge signals in the intermediate frequency band and the high frequency band to each other enables generating an edge signal ranging from an intermediate frequency to a high frequency. As a result, a resolution sense in the solid-state imaging device can be inexpensively and assuredly improved.

It is to be noted that parameters of DCFs 150A, 150B, 150C and 150D can be changed in areas in accordance with a circuit scale. Moreover, likewise, on the subsequent stage of DCF 150A for pixels W in FIG. 22, the contour extraction circuit 135 can be provided to perform contour extraction as shown in FIG. 1 and the level adjustment circuit 136 and contour signal addition circuits 137, 138 and 139 can be provided to execute processing.

Additionally, likewise, on the subsequent stage of DCFs 150D, 150B and 150C for the respective signals B, G and R in FIG. 23, respective contour extraction circuits 140, 141 and 142 can be provided to perform contour extraction as shown in FIG. 10 and a contour signal combination circuit 143, the level adjustment circuit 136 and the contour signal addition circuits 137, 138 and 139 can be provided to execute processing.

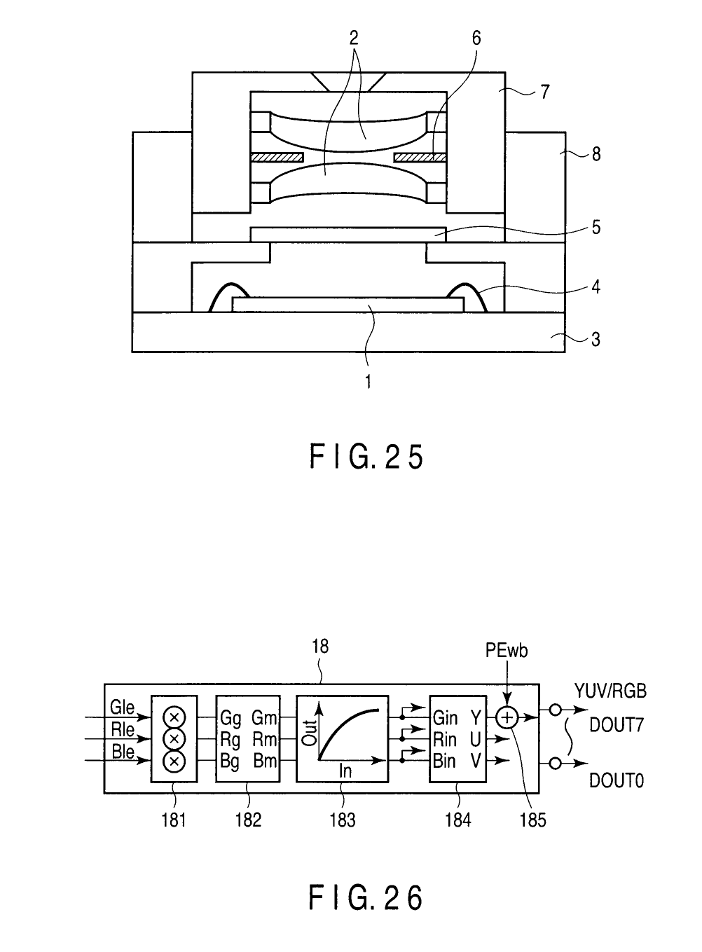

An example that an embodiment is applied to a camera module utilized in, e.g., a mobile phone will now be described. FIG. 25 is a cross-sectional view of a camera module when the embodiment is applied to the camera module.

A sensor chip 1 is fixed on a substrate 3 formed of, e.g., glass epoxy through an adhesive. A pad of the sensor chip 1 is connected to a connection terminal of the substrate 3 through wire bonding 4. Although not shown, the connection terminal is drawn out onto a side surface or a bottom surface of the substrate 3.

A panel of infrared (IR) cut glass 5, two optical lenses 2, and a diaphragm 6 provided between the two lenses 2 are arranged above the sensor chip 1. The optical lenses 2 and the diaphragm 6 are fixed to a lens barrel 7 through a resin such as plastic. Further, the lens barrel 7 is fixed on a lens holder 8. It is to be noted that a phase-shift plate is arranged between the sensor chip 1 and the lenses 2 as required in the embodiment.

In general, the number of the optical lenses 2 increases as the number of pixels formed in the sensor chip increases. For example, in a camera module including a sensor chip which has 3.2 megapixels, three lenses are often utilized.

It is to be noted that the sensor chip 1 is, e.g., a CMOS image sensor surrounded by a broken line in each of the embodiments shown in FIGS. 1, 10, 13, 22, 23, and 24. Furthermore, the sensor chip 1 may be formed by adding other functions to such a CMOS image sensor.

In the embodiment, to increase depth of field, an optical lens having a lens aberration is utilized as an optical lens for use in a color solid-state imaging device. Alternatively, a phase-shift plate is arranged on an optical axis of the optical lens. In other words, the phase-shift plate is arranged between the optical lens and the sensor chip. Further, a resolution signal is extracted from a photoelectrically transformable wavelength domain of a photoelectric transducer, and the resolution signal is combined with each signal R, G or B or a luminance signal. In particular, using a signal W obtained from a pixel W (transparent) enables increasing a resolution signal level. Where a chromatically aberrant lens and a spherically aberrant lens are employed as optical lenses, the depth of field can be increased further. Where the chromatically and spherically aberrant lenses are employed and a phase-shift plate is provided, the depth of field can be increased still further.

According to the embodiment, the solid-state imaging device that can increase the depth of field without lowering the resolution signal level can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a sensor unit having a transparent (W) filter and color filters of at least two colors which separate wavelengths of light components that have passed through an optical lens having at least one of spherical aberration and chromatic aberration, the sensor unit converting light that has passed through the transparent filter into a signal W and converting light components that have passed through the color filters into at least first and second color signals;
a resolution extraction circuit which extracts a resolution signal from signal W converted by the sensor unit; and
a generation circuit which generates red (R), green (G) and blue (B) signals from signal W and the first and second color signals converted by the sensor unit.

2. The device according to claim 1,
wherein a peak transmission factor of the transparent filter is lower than a peak transmission factor of each color filter.

3. The device according to claim 1,
wherein the transparent filter comprises a transparent layer which has a lowered transmission factor of each color filter in a wavelength domain.

4. The device according to claim 1,
wherein the resolution extraction circuit comprises a high-pass filter circuit which extracts a high-frequency signal, and the high-pass filter circuit extracts the resolution signal.

5. The device according to claim 1, further comprising at least one of:
a combination circuit which combines the resolution signal extracted by the resolution extraction circuit with the red (R), green (G) and blue (B) signals generated by the generation circuit; and
a combination circuit which combines the resolution signal with a luminance (Y) signal of a YUV signal.

6. A solid-state imaging device comprising:
a sensor unit having a transparent (W) filter and color filters of at least two colors which separate wavelengths of light components that have passed through an optical lens and a phase-shift plate, the sensor unit converting light that has passed through the transparent filter into a signal W and converting light components that have passed through the color filters into at least first and second color signals;
a resolution extraction circuit which extracts a resolution signal from signal W converted by the sensor unit; and
a generation circuit which generates red (R), green (G) and blue (B) signals from signal W and the first and second color signals converted by the sensor unit.

7. The device according to claim 6,
wherein a peak transmission factor of the transparent filter is lower than a peak transmission factor of each color filter.

8. The device according to claim 6,
wherein the transparent filter comprises a transparent layer which has a lowered transmission factor of each color filter in a wavelength domain.

9. The device according to claim 6,
wherein the resolution extraction circuit comprises a high-pass filter circuit which extracts a high-frequency signal, and the high-pass filter circuit extracts the resolution signal.

10. The device according to claim 6, further comprising at least one of:
a combination circuit which combines the resolution signal extracted by the resolution extraction circuit with signals R, G and B generated by the generation circuit; and
a combination circuit which combines the resolution signal with a luminance (Y) signal of a YUV signal.

11. A solid-state imaging device comprising:
a sensor unit having color filters of three colors which separate wavelengths of light components that have passed through an optical lens having at least one of spherical aberration and chromatic aberration, the sensor unit converting light components that have passed through the color filters into color signals, respectively;
a resolution extraction circuit which extracts a resolution signal from the color signals converted by the sensor unit; and
a generation circuit which generates red (R), green (G) and blue (B) signals from the color signals converted by the sensor unit.

12. The device according to claim 11,
wherein the resolution extraction circuit comprises a high-pass filter circuit which extracts a high-frequency signal, and the high-pass filter circuit extracts the resolution signal.

13. The device according to claim 11, further comprising at least one of:
a combination circuit which combines the resolution signal extracted by the resolution extraction circuit with signals R, G and B generated by the generation circuit; and
a combination circuit which combines the resolution signal with a luminance (Y) signal of a YUV signal.

14. A solid-state imaging device comprising:
a sensor unit having color filters of three colors which separate wavelengths of light components that have passed through an optical lens and a phase-shift plate, the sensor unit converting light components that have passed through the color filters into color signals, respectively;
a resolution extraction circuit which extracts a resolution signal from the color signals converted by the sensor unit; and
a generation circuit which generates red (R), green (G) and blue (B) signals from the color signals converted by the sensor unit.

15. The device according to claim 14,
wherein the resolution extraction circuit comprises a high-pass filter circuit which extracts a high-frequency signal, and the high-pass filter circuit extracts the resolution signal.

16. The device according to claim 14, further comprising at least one of:
a combination circuit which combines the resolution signal extracted by the resolution extraction circuit with signals R, G and B generated by the generation circuit; and
a combination circuit which combines the resolution signal with a luminance (Y) signal of a YUV signal.

17. A camera module comprising:
an imaging unit arranged on a substrate, the imaging unit comprising:
a sensor unit having a transparent (W) filter and color filters of at least two colors which separate wavelengths of light components that have passed through an optical lens having at least one of spherical aberration and chromatic aberration, the sensor unit converting light that has passed through the transparent filter into a signal W and converting light components that have passed through the color filters into at least first and second color signals;
a resolution extraction circuit which extracts a resolution signal from signal W converted by the sensor unit; and
a generation circuit which generates red (R), green (G) and blue (B) signals from signal W and the first and second color signals converted by the sensor unit, and
a lens barrel having the optical lens arranged on the imaging unit.

18. The camera module according to claim 17,
wherein a peak transmission factor of the transparent filter is lower than a peak transmission factor of each color filter.

19. The camera module according to claim 17,
wherein the transparent filter comprises a transparent layer which has a lowered transmission factor of each color filter in a wavelength domain.

20. The camera module according to claim 17,
wherein the resolution extraction circuit comprises a high-pass filter circuit which extracts a high-frequency signal, and the high-pass filter circuit extracts the resolution signal.

21. The camera module according to claim 17, further comprising at least one of:
a combination circuit which combines the resolution signal extracted by the resolution extraction circuit with the red (R), green (G) and blue (B) signals generated by the generation circuit; and
a combination circuit which combines the resolution signal with a luminance (Y) signal of a YUV signal.
